(19) United States
(12) Patent Application Publication
(10) Pub. No.: US 2026/0245207 A1
(43) Pub. Date: Aug. 20, 2026

(54) MULTI-VIEW COLLABORATIVE PLANT IN-SITU ACQUISITION SYSTEM, ACQUISITION METHOD, AND DIGITAL TWIN ANALYSIS METHOD

(71) Applicant: NANJING FORESTRY UNIVERSITY, Nanjing (CN)

(72) Inventors: Huichun ZHANG, Nanjing (CN); Zhencan WANG, Nanjing (CN); Liming BIAN, Nanjing (CN); Lei ZHOU, Nanjing (CN); Hongping ZHOU, Nanjing (CN)

(73) Assignee: NANJING FORESTRY UNIVERSITY, Nanjing (CN)

(21) Appl. No.: 19/641,564

(22) Filed: Apr. 8, 2026

(30) Foreign Application Priority Data
Nov. 20, 2025 (CN) 202511710238.8

(51) Int. Cl. G06T 7/00; G06T 7/11; G06T 17/20; G06V 10/26; G06V 10/774; G06V 20/10; G06V 20/70; H04N 23/57; H04N 23/695; G06V 10/10

(52) U.S. Cl. CPC G06T 7/0012; G06T 7/11; G06T 17/20; G06V 10/267; G06V 10/774; G06V 20/188; G06V 20/70; H04N 23/57; H04N 23/695; G06T 2207/10028; G06T 2207/20081; G06T 2207/30168; G06T 2207/30188; G06T 2210/56; G06V 10/16

(57) ABSTRACT

The present invention discloses a multi-view collaborative plant in-situ phenotype acquisition system and a method for collecting and digital twin analysis, comprising a hardware acquisition platform, which comprises a drive wheel module, an omni-directional wheel, a multi-view imaging module and a frame support module; the multi-view imaging module includes a rotary motor, a rotating platform, a reverse U-shaped rotary arm, a stepper motor, a synchronous pulley, a synchronous belt, a small cart, an installation bracket, a visible light camera, and an idler. The hardware acquisition platform enables in-situ, non-destructive, multi-view image acquisition of individual plants in a controlled and natural environment. The supporting analysis method reconstructs the multi-view image sequence into a digital twin model with topological rationality, structural integrity and high fidelity.

### CROSS REFERENCE OF RELATED APPLICATION

This patent application claims the benefit of and priority to Chinese Patent Application No. 202511710238.8, filed with the China National Intellectual Property Administration on November 20, 2025, the disclosure of which is incorporated by reference herein in its entirety as part of the present application.

### FIELD OF THE INVENTION

The present invention discloses a multi-view collaborative plant in-situ phenotype acquisition system, a multi-view plant visible light image acquisition method, and a method for acquiring and analyzing plant in-situ phenotypes, belonging to the field of plant phenotype information acquisition devices and digital twin modeling. More specifically, it relates to a single-plant scale plant phenotype analysis system that integrates automated data acquisition equipment and three-dimensional digital twin modeling method.

### BACKGROUND OF THE INVENTION

Plant phenotype, as the sum of the morphological, structural, and functional characteristics of a plant that are presented under the combined action of genetics and environment, has important research value in fields such as genetic breeding, plant physiology, and precision agriculture. In recent years, with the development of computer vision and sensor technology, automated, high-throughput plant phenotype platforms have gradually become important tools for analyzing plant traits. Digital twin models can provide key technical support for precise plant phenotype analysis, virtual growth simulation, and environmental adaptation studies. However, existing technologies still have the following limitations when performing in-situ, precise, and detailed three-dimensional structural analysis of single plants in controlled or natural environments:
(1) The acquisition method cannot achieve truly "in-situ" high-throughput measurements. Most single-plant three-dimensional imaging platforms currently use the "plant rotation-camera fixed" imaging mode. The inherent disadvantage of this method is that it relies on manual transfer of the plant to be measured from a controlled or natural growth environment to the device, which is not only cumbersome and inefficient, but also seriously disrupts the plant's original growth state, making it impossible to achieve true in-situ, non-destructive, and intelligent monitoring. Related patents such as "A Plant Phenotype Acquisition Device and Its Acquisition Method (CN114659463A)", "A Plant Phenotype Acquisition Device and Its Acquisition Method (CN110530285B)", and utility model patent "A Plant Three-Dimensional Phenotype Information Acquisition Device (CN215177543U)" all reflect these inherent limitations.
(2) The modeling process has not yet achieved the integrated integration from raw data to model. Existing technologies are only at the "point cloud shell" stage, and mainly focus on independent stages such as point cloud reconstruction, semantic segmentation, or skeleton extraction. These stages are disconnected from each other, there is no necessary connection, and there is a lack of an end-to-end unified processing framework.
(3) Technical gaps in key stages hinder the implementation of automated modeling. Although current semantic segmentation and skeleton extraction algorithms (such as the semantic-aware Laplace method) can accurately extract plant skeletons, the problem of automatically reconstructing three-dimensional models with correct topology and geometric continuity from discrete data sources (such as skeleton points and single leaf point cloud models) remains a "last mile" challenge. Therefore, developing dedicated modeling tools that can automatically parse skeleton information and complete component assembly, and achieve seamless conversion from data to model, has become a core bottleneck for the development of plant digital twin technology.

### SUMMARY OF THE INVENTION

The technical problem that the present invention aims to solve is to provide a multi-view collaborative plant in-situ phenotype acquisition system and acquisition and digital twin analysis method to address the shortcomings of the existing technologies. The system is mounted on a hardware acquisition platform and achieves multi-perspective in-situ image acquisition of plants under different heights and angles through the coordinated operation of vertical and horizontal adjustment mechanisms; based on the acquired images, a high-precision dense point cloud of the plant is reconstructed, and further through an integrated analysis process, including semantic segmentation, skeleton extraction, and modeling, to achieve end-to-end digital twin model construction, providing key technical support for precise plant phenotype analysis, virtual growth simulation, and environmental adaptation studies.

To achieve the above technical objectives, the technical solution adopted by the present invention is:

A multi-view collaborative plant in-situ phenotype acquisition system, includes a hardware acquisition platform; the hardware acquisition platform includes a driving wheel module 1, omni-directional wheels 3, a multi-view imaging module 4, and a frame support module 5; the front sides of the frame support module 5 are equipped with omni-directional wheels 3 at their bottom, and the rear sides are equipped with a driving wheel module 1 at their bottom;

the multi-view imaging module 4 includes a rotary motor 4-1, a rotating platform 4-4, a reverse U-shaped rotary arm, a stepper motor 4-6, a small cart, an installation bracket 4-16, and a visible light camera 4-17; the reverse U-shaped rotary arm is located inside the frame support module 5, including a horizontal rod 4-3 and two downward-extending arms 4-7 fixed at the ends of the horizontal rod 4-3; the rotating platform 4-4 includes a fixed component and a rotary component; the fixed component is connected to the frame support module 5, and the rotary motor 4-1 is mounted on the fixed component; the output of the rotary motor 4-1 is connected to the rotary component, and the rotary component is connected to the center of the horizontal rod 4-3 in the reverse U-shaped rotary arm; the rotating component is connected to the central part of the horizontal rod 4-3 within the reverse U-shaped rotary arm; the rotary motor 4-1 drives the rotating component and reverse U-shaped rotary arm to rotate relative to the fixed component; the small cart is slidingly or rollably connected to the downward-extending arm 4-7; the installation bracket 4-16 is connected to the small cart, and the installation bracket 4-16 is used to clamp the visible light camera 4-17 and adjust the angle of the visible light camera 4-17; the reverse U-shaped rotary arm is equipped with a stepper motor 4-6, the stepper motors 4-6 are connected to the small cart via a belt drive mechanism, the stepper motors 4-6 drive the small cart, the installation bracket 4-16, and visible light camera 4-17 to move vertically along the downward-extending arm 4-7.

As a further improvement to the above-mentioned the multi-view collaborative plant in-situ phenotype acquisition system, the transmission mechanism includes a synchronous pulley 4-9, a synchronous belt 4-10, a pulley slot 4-18, and an idler 4-20; the output of the stepper motor 4-6 is connected to the synchronous pulley 4-9; a pulley slot 4-18 is set on the bottom side of the downward-extending arm 4-7; The idler 4-20 rotates within the pulley slot 4-18; the idler 4-20 is connected to the synchronous pulley 4-9 through the synchronous belt 4-10; and the small cart is connected to the synchronous belt 4-10.

As a further improvement to the above-mentioned the multi-view collaborative plant in-situ phenotype acquisition system, the multi-view imaging module 4 further includes a clamping board 4-11 and a second connecting plate 4-13; the small cart includes a first load plate 4-14, a second load plate 4-15, and rollers 4-19; the first load plate 4-14 and the second load plate 4-15 are located on the sides of the downward-extending arm 4-7; the downward-extending arm 4-7 has rollers 4-19 on the other sides; the rollers 4-19 are rotatably mounted on the first load plate 4-14 or the second load plate 4-15; the rollers 4-19 are in rolling contact with the sides of the downward-extending arm 4-7; the first load plate 4-14 is connected to the second load plate 4-15 through a fixed column;

the clamping board 4-11 and the second connecting plate 4-13 are connected by bolts, and the synchronous belt 4-10 is clamped between the clamping board 4-11 and the second connecting plate 4-13; and the first load plate 4-14 or the second load plate 4-15 is directly or indirectly fixed to the second connecting plate 4-13.

As a further improvement to the above-mentioned the multi-view collaborative plant in-situ phenotype acquisition system, the driving wheel module 1 includes a wheel 1-2, a chain 1-3, a driven sprocket 1-4, a driving sprocket 1-5, and a sprocket-driven motor 1-6; the sprocket-driven motor 1-6 is set on the frame support module 5; the wheel 1-2 is rotatably connected to the frame support module 5; the flange fixed on the wheel 1-2 is fixed with the driven sprocket 1-4; the driven sprocket 1-4 is connected to the driving sprocket 1-5 through the chain 1-3; and the driving sprocket 1-5 is connected to the output shaft of the sprocket-driven motor 1-6.

As a further improvement to the above-mentioned the multi-view collaborative plant in-situ phenotype acquisition system, the frame support module 5 further includes a controller and a power supply; the sprocket-driven motor 1-6 in the drive wheel module 1, the rotary motor 4-1, stepper motor 4-6, and visible light camera 4-17 in the multi-view imaging module 4 are all connected to the controller; the sprocket-driven motor 1-6, rotary motor 4-1, stepper motors 4-6, visible light camera 4-17, and controller are all connected to the power supply.

The present invention also provides a multi-view plant visible light image acquisition method, using the multi-view cooperative plant in-situ phenotype collection system.

A method for acquiring multi-view visible light images of plants, using the multi-view collaborative plant in-situ phenotype acquisition system described above, the acquisition steps include:

(A1) moving the hardware acquisition platform to the target area, that is, by controlling the drive wheel module 1 to maneuver the hardware acquisition platform into the phenotype acquisition zone, ultimately placing the plant in the central position of the multi-view imaging module 4 within the hardware acquisition platform;

(A2) adjusting the height of the visible light camera 4-17 according to the plant height using stepper motors 4-6;

(A3) adjusting the shooting angle of the visible light camera 4-17 by the installation bracket 4-16; after that, the visible light camera 4-17 takes a view, and after taking the view, collects an image;

(A4) starting the rotary motor 4-1, rotating the rotating component within the rotating platform 4-4, thereby synchronously rotating the reverse U-shaped rotary arm, which in turn rotates the visible light camera 4-17 on the cart, after rotating to a certain angle, the rotary motor 4-1 stops rotating;

(A5) repeating steps (A3) and (A4) until the entire circumference of the image is acquired.

As a further improvement to the above-mentioned the method for acquiring multi-view visible light images of plants, the acquisition steps specifically include:

(A1) moving the hardware acquisition platform to the target area, i.e., controlling the sprocket-driven motor 1-6 in driving wheel module 1 to move the hardware acquisition platform to the phenotype acquisition area, ultimately placing the plant in the central position of the multi-view imaging module 4 within the hardware acquisition platform;

if the plant height is below the preset height, steps (A2) to (A5) are executed; if the plant height is above the preset height, steps (A6) to (A9) are executed;

(A2) adjusting the height of the visible light camera 4-17 using the stepper motors 4-6 according to the plant height; specifically, the stepper motor 4-6 moves the synchronous pulley 4-9 through the synchronous belt 4-10, the synchronous belt 4-10 drives the cart and the visible light camera 4-17 to move up and down until they are adjusted to the appropriate height;

(A3) adjusting the shooting angle of the visible light camera 4-17 by installation bracket 4-16 so that the shooting angle is parallel to the plant; after that, the visible light camera 4-17 takes a view, and after taking the view, collects an image;

(A4) starting the rotary motor 4-1, rotating the rotating component within the rotating platform 4-4, thereby synchronously rotating the reverse U-shaped rotary arm, which in turn rotates the visible light camera 4-17 on the cart, after rotating to a certain angle, the rotary motor 4-1 stops rotating;

(A5) repeating steps (A3) and (A4) until the entire circumference of the image is acquired;

(A6) starting the stepper motor 4-6, the stepper motor 4-6 moves the synchronous belt 4-10 through the synchronous pulley 4-9, the synchronous belt 4-10 moves the cart and the visible light camera 4-17 downwards, and moves the visible light camera 4-17 to the bottom of the downward-extending arm 4-7;

(A7) adjusting the shooting angle of the visible light camera 4-17 by installation bracket 4-16 so that the shooting angle is parallel to the plant; set the visible light camera 4-17 to scanning mode, then start the stepper motor 4-6, drives the visible light camera 4-17 to move vertically upward and scan the entire plant, the visible light camera 4-17 has an integrated splicing algorithm to real-time splice the scanning image, after generating the entire plant image, stop scanning;

(A8) starting the rotary motor 4-1, rotating the rotating component within the rotating platform 4-4, thereby synchronously rotating the reverse U-shaped rotary arm, which in turn rotates the visible light camera 4-17 on the cart, after rotating to a certain angle, the rotary motor 4-1 stops rotating;

(A9) repeat steps (A6)-(A8) until the entire week of image acquisition of the plant is completed.

The invention also provides a plant in-situ phenotype collection and digital twin analysis method, using the above-mentioned multi-view plant visible light image acquisition method to collect multi-view visible light images of multiple plants, and then performing the digital twin analysis step.

A method for in-situ plant phenotype acquisition and digital twin analysis, using the multi-view visible light image acquisition method described above to acquire multiple plants' multi-view visible light images, then performing the digital twin analysis steps;

the digital twin analysis steps include:

(B1) inputting each plant's multi-view visible light image into the algorithm based on motion recovery structure and multi-view 3D for processing, generating a dense 3D point cloud for each plant, and performing pre-processing operations on the dense 3D point cloud of each plant to obtain the pre-processed point cloud data for each plant;

(B2) point cloud segmentation:

(B21) constructing a point cloud training dataset for leaf and stem systems based on pre-processed point cloud data for each plant, as well as a point cloud training dataset for petioles and main stems; the point cloud training dataset for leaf and stem systems includes complete point clouds of individual plants and the results of partitioning the point cloud of an individual plant; the results of partitioning the point cloud of an individual plant include a leaf point cloud and a stem system point cloud; the point cloud training dataset for petioles and main stems includes point clouds belonging to the stem system and the results of partitioning the point clouds belonging to the stem system ; the results of partitioning the point clouds belonging to the stem system include a main stem point cloud and a petiole point cloud ;

(B22) training the first segmentation model using the point cloud training dataset for leaf and stem systems, resulting in the first-stage segmentation model after training; training the second-stage segmentation model using the point cloud training dataset for petioles and main stems, resulting in the second-stage segmentation model after training; both the first-stage segmentation model and the second-stage segmentation model utilize a PointNet++ multi-scale grouping MSG architecture;

(B23) the plant point cloud data obtained through step (B1) is input into the trained first-stage segmentation model, dividing it into leaf point cloud and stem system point cloud, the stem system point cloud is then input into the trained second-stage segmentation model, dividing it into main stem point cloud and petiole point cloud, the results from the first-stage segmentation model and the second-stage segmentation model are fused to obtain a semantically annotated point cloud where each point is labeled as belonging to a leaf, main stem, or petiole;

(B3) based on the main stem point cloud and petiole point cloud extracted in step (B23), the Laplace contraction algorithm is used to extract the skeleton point set of the stem system; using the segmented main stem point cloud and petiole point cloud, dynamic weights are applied during the point cloud contraction process to extract an unordered skeleton point set; the unordered skeleton point set is then established into a skeleton topology connection using the Minimum Spanning Tree algorithm, generating a skeleton graph;

(B4) based on the leaf point cloud extracted in step (B23), a leaf mesh model is constructed;

(B5) constructing a digital twin model:

based on the skeleton graph generated in step (B3), the main stem point cloud and petiole point cloud in the stem system are identified, the main stem point cloud is fitted to generate a smooth and continuous main stem path; the petiole point cloud is fitted to generate a petiole path; along the fitted main stem path and petiole path, a sweeping surface reconstruction method is used to generate a physical model of the stem system;

the leaf mesh model and the stem system physical model are connected and integrated to form a complete digital twin model of the plant; the plant's phenotypic parameters are obtained through the digital twin model and a scaling factor.

As a further improvement to the above-mentioned the method for in-situ plant phenotype acquisition and digital twin analysis, that step (B4) specifically comprises:

based on the leaf point cloud obtained in step (B23), constructing a leaf mesh model using an adaptive reconstruction method;

specifically, the adaptive reconstruction method comprises the following steps:

step (B41), identifying and enhancing sparse regions in the leaf point cloud data;

step (B42), automatically estimating initial reconstruction parameters based on three key features of the leaf point cloud data, where the key features of the point cloud data specifically include: point cloud size, point cloud data density, and leaf physical dimensions, based on these three key features, initial reconstruction parameters are automatically estimated, including the number of target sampling point, MLS search radius, Poisson reconstruction depth, ball radius multiplier, and maximum number of nearest neighbor; establish a three-dimensional mesh model of the leaf based on initial reconstruction parameters;

step (B43), evaluating the quality of the three-dimensional mesh model using metrics, including: mesh integrity, geometric accuracy, and coverage completeness, the total score is calculated by weighting all metrics to obtain the quality evaluation result;

step (B44), adjusting the reconstruction parameters based on the quality evaluation result, when continuous adjustments do not improve the results or reach the quality requirements, optimization is stopped and the results are output.

As a further improvement to the above-mentioned the method for in-situ plant phenotype acquisition and digital twin analysis, that step (B5) specifically comprises:

step (B51), identifying key connection points by counting the number of connections between skeletal nodes: nodes with three edges are stem-petiole junctions, using stem-petiole junctions as a basis, PCA is applied to extract the main stem main axis direction, establishing a global spatial reference system;

step (B52), the angle formed by the vector from the stem-petiole junction to the terminal point relative to the main stem axis is denoted as θₙ, the stem-petiole junction node satisfies the following condition: the distance from the stem-petiole junction to the terminal point is minimized, and an intermediate connection point exists between the stem-petiole junction and the terminal point, when θₙ > 20°, the terminal point is classified as the petiole terminal point ; otherwise, it is classified as the main stem terminal point,

step (B53), applying B-spline curve fitting to the sequence of main stem nodes to generate a smooth and continuous center path, use the straight line fitting method for the petiole nodes to generate the corresponding petiole path; along the fitted main stem path and petiole path, a stem system entity model is generated using a sweeping surface reconstruction method;

step (B54), connecting and integrating the leaf mesh model and the stem system entity model in space to form a complete plant digital twin model, the phenotypic parameters of the plant are obtained through the plant digital twin model and a scaling factor, where the scaling factor includes the ratio between the actual plant and the plant point cloud, and the ratio between the plant point cloud and the plant digital twin model.

The beneficial effects of the present invention are as follows.

The present invention system consists of a hardware acquisition platform and a software modeling module, enabling multi-view image acquisition of individual plants in both controlled and natural environments. Based on this, it enables in-depth phenotypic analysis and digital twin modeling, thereby forming a complete technology chain from data acquisition to high-level applications.

The present invention proposes a multi-view collaborative plant in-situ phenotypic acquisition system and a method for acquiring and analyzing digital twins. This system is mounted on an autonomous mobile platform, and through the coordinated operation of vertical and horizontal adjustment mechanisms, it achieves multi-view in-situ image acquisition of plants under different heights and angles. Based on the acquired images, Structure from Motion (SFM) and Multi-View Stereo (MVS) algorithms are used to reconstruct a high-precision dense point cloud of the plant, and further, a comprehensive analysis process—including semantic segmentation, skeleton extraction, and parametric modeling—is employed to build an end-to-end digital twin model. Specifically, the present invention has developed dedicated parametric modeling components that can automatically identify the plant's topology, generate parametric stem system models, and precisely assemble them with a pre-built leaf mesh model library, ultimately forming a complete, topologically sound, and directly usable high-fidelity digital twin model.

### BRIEF DESCRIPTION OF THE DRAWINGS

The patent application contains drawings executed in color. Copies of this patent or patent application publication with color drawings will be provided by the Office upon request and payment of the necessary fee.

FIG. 1 is the overall schematic diagram of the invention.

FIG. 2 is the front view of the invention.

FIG. 3 is the left view of the invention.

FIG. 4 is the top view of the invention.

FIG. 5 is the diagram of the driving wheel module.

FIG. 6 is the diagram of the multi-view imaging module.

FIG. 7 is the enlarged view of A in FIG. 6.

FIG. 8 is the enlarged view of B in FIG. 6.

FIG. 9 is the enlarged view of C in FIG. 6.

FIG. 10 is the installation bracket.

FIG. 11 is the schematic diagram of the motion process of the multi-view imaging module.

FIG. 12 is the flowchart of multi-view image acquisition.

FIG. 13 is the overall process diagram of the plant digital twin modeling framework.

FIG. 14 is the principle diagram of stem system skeleton parsing and modeling.

FIG. 15 is the overall interface diagram of the developed digital twin modeling integrated platform.

FIG. 16 is the detailed panel module diagram of the developed digital twin modeling integrated platform.

FIG. 17 is the original point cloud diagram (i.e., FIG. (a2), (b2), (c2), (d2)) and the digital twin model constructed by the present invention (i.e., FIG. (a1), (b1), (c1), (d1)).

FIG. 18(a) - FIG. 18(f) are scatter plots of correlation between manually measured phenotypic parameters and model-estimated phenotypic parameters.

FIG. 18(a) is the scatter plot of correlation between plant height measurement and estimated value.

FIG. 18(b) is the scatter plot of correlation between crown diameter measurement and estimated value.

FIG. 18(c) is the scatter plot of correlation between leaf length measurement and estimated value.

FIG. 18(d) is the scatter plot of correlation between leaf width measurement and estimated value.

FIG. 18(e) is the scatter plot of correlation between petiole base angle measurement and estimated value.

FIG. 18(f) is the scatter plot of correlation between petiole inclination angle measurement and estimated value.

In the figure:

1: driving wheel module, 2: individual plant, 3: omni-directional wheel, 4: multi-view imaging module, 5: frame support module,

1-1: driving wheel bracket, 1-2: wheel, 1-3: chain, 1-4: driven sprocket, 1-5: driving sprocket, 1-6: sprocket-driven motor, 1-7: sprocket-driven motor mounting plate,

4-1: rotary motor, 4-2: transition plate, 4-3: horizontal rod, 4-4: rotating platform, 4-5: stepper motor mounting plate, 4-6: stepper motor, 4-7: downward-extending arm, 4-8: stepper motor support, 4-9: synchronous pulley, 4-10: synchronous belt, 4-11: clamping board, 4-12: first connecting plate, 4-13: second connecting plate, 4-14: first load plate, 4-15: second load plate, 4-16: installation bracket, 4-17: visible light camera, 4-18: pulley slot, 4-19: roller, 4-20: idler,

4-16-1: bracket base, 4-16-2: angle locking mechanism, 4-16-3: clamping device, 4-16-4: spherical hinge rod, 4-16-5: clamping ring.

### DETAILED DESCRIPTION OF THE INVENTION

In order to overcome the shortcomings of existing plant phenotype analysis technology in collection methods and modeling processes, the present invention proposes a multi-perspective collaborative plant in-situ phenotype collection system and a collection and digital twin analysis method. The system consists of a hardware acquisition platform and a software modeling module, enabling multi-view image acquisition of individual plants in both controlled and natural environments. Based on this, it facilitates in-depth phenotype analysis and digital twin modeling, forming a complete technology chain from data acquisition to high-level applications.

To achieve the above objectives, this invention employs the following technical solution.

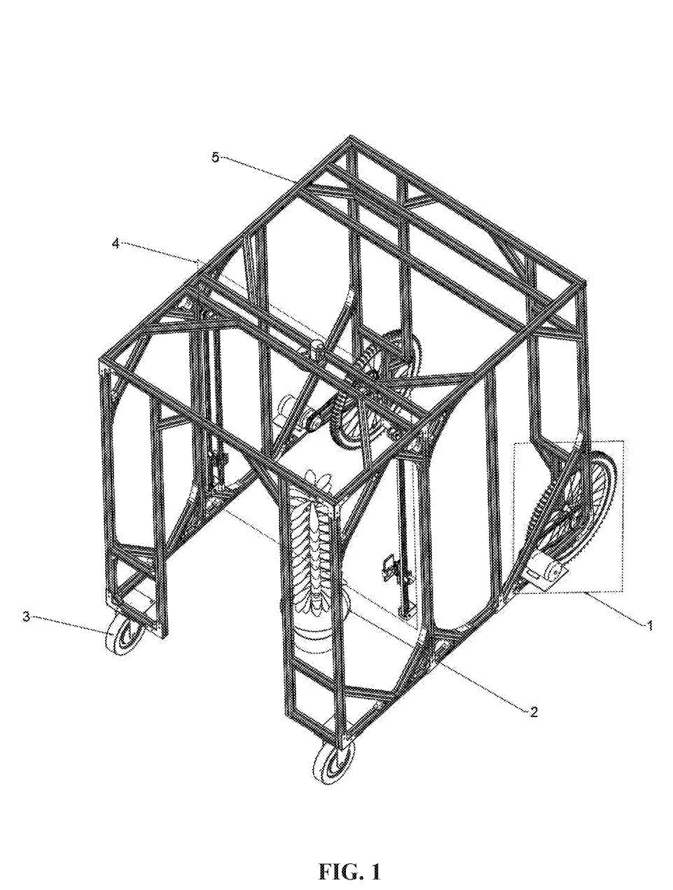

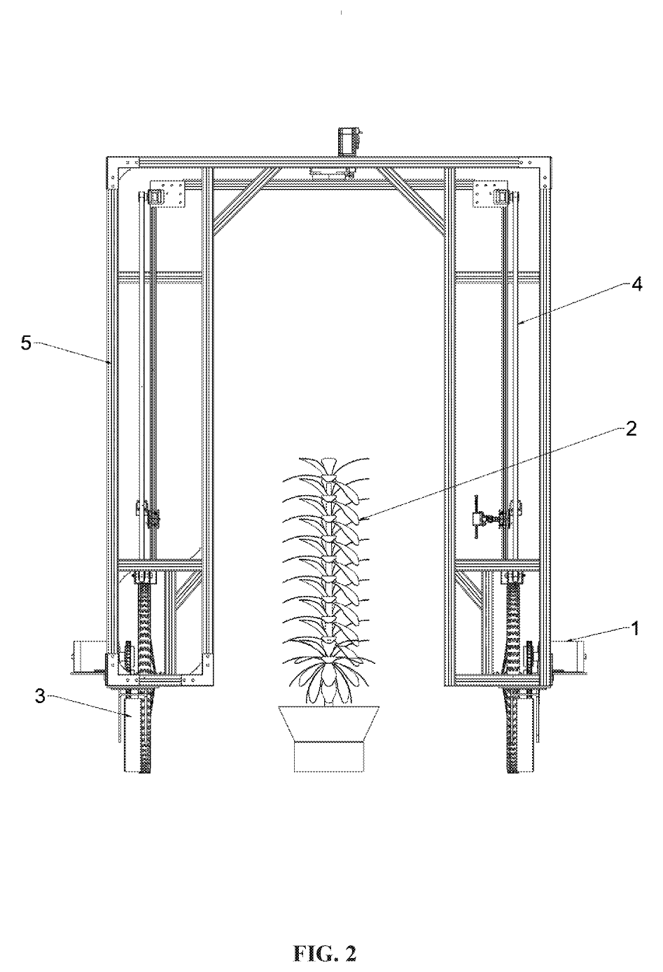

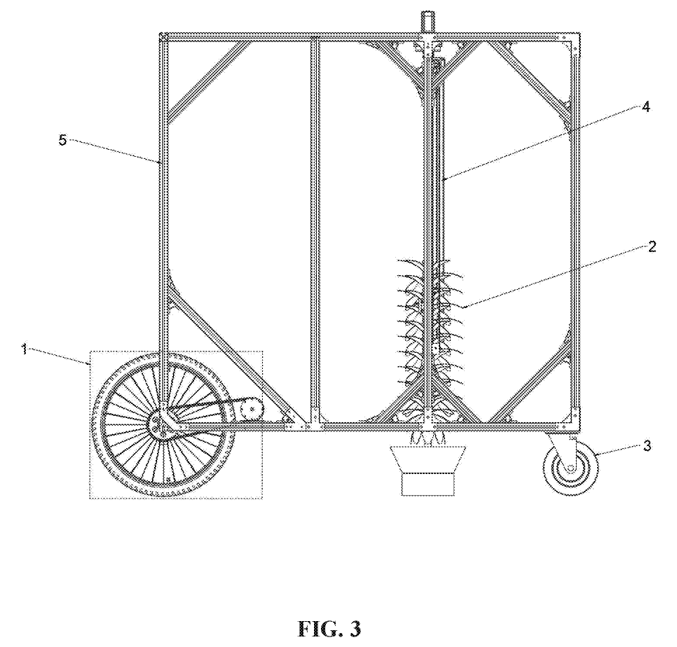

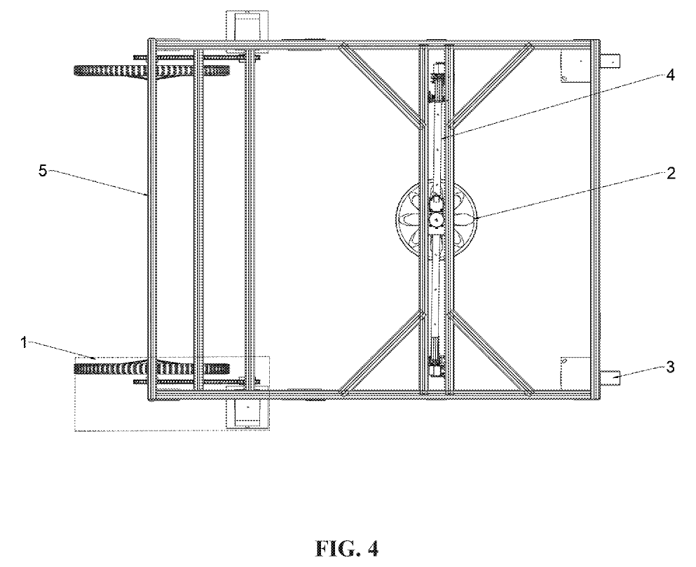

As shown in FIGS. 1-4, a multi-view collaborative plant in-situ phenotype acquisition system includes a hardware acquisition platform. The hardware acquisition platform comprises a driving wheel module 1, omni-directional wheels 3, a multi-view imaging module 4, and a frame support module 5.

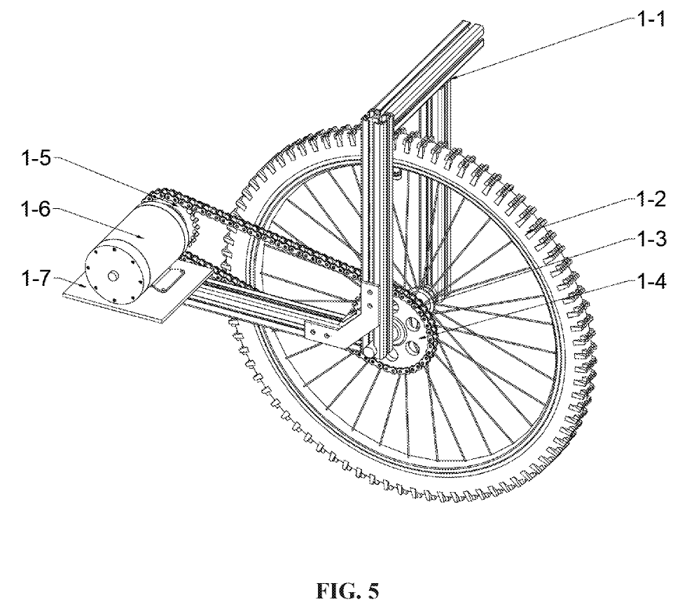

As shown in FIG. 5, the driving wheel module 1 includes: an aluminum profile driving wheel bracket 1-1, the wheels 1-2, the chains 1-3, a driven sprockets 1-4, the driving sprockets 1-5, the sprocket-driven motors 1-6, and the sprocket-driven motor mounting plates 1-7. Two wheels 1-2, both are rotatably connected to the driving wheel bracket 1-1, two driving wheel brackets 1-1 are fixed on the rear left and right sides of the frame support module 5. The flange fixed on the wheel 1-2 is fixed with a driven sprocket 1-4. The driven sprocket 1-4 is engaged with the driving sprocket 1-5 through a chain 1-3. The driving sprocket 1-5 is fixed on the output shaft of the sprocket-driven motor 1-6 through a key connection. The sprocket-driven motor 1-6 is mounted on the sprocket-driven motor mounting plate 1-7, and the sprocket-driven motor mounting plate 1-7 is mounted on the frame support module 5, and both are fixed together with bolts and nuts.

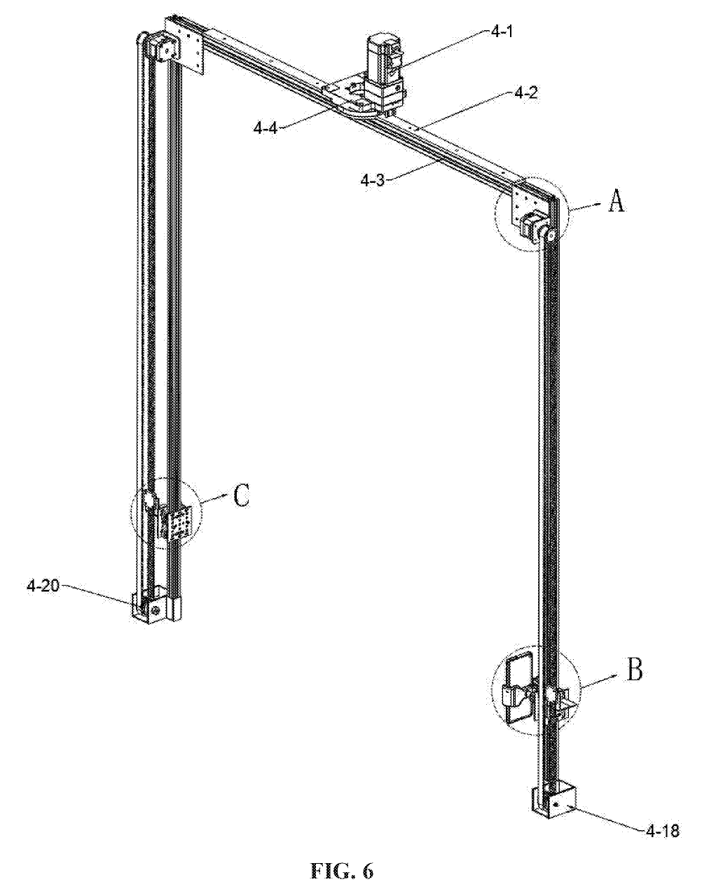

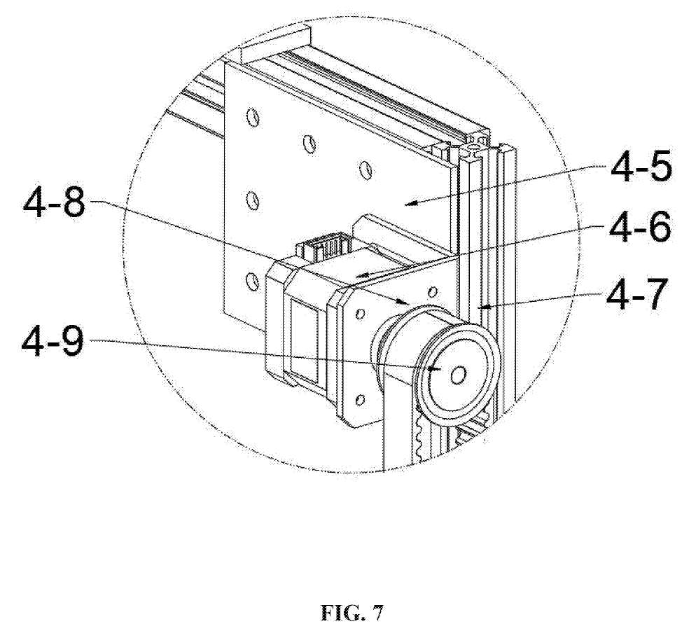

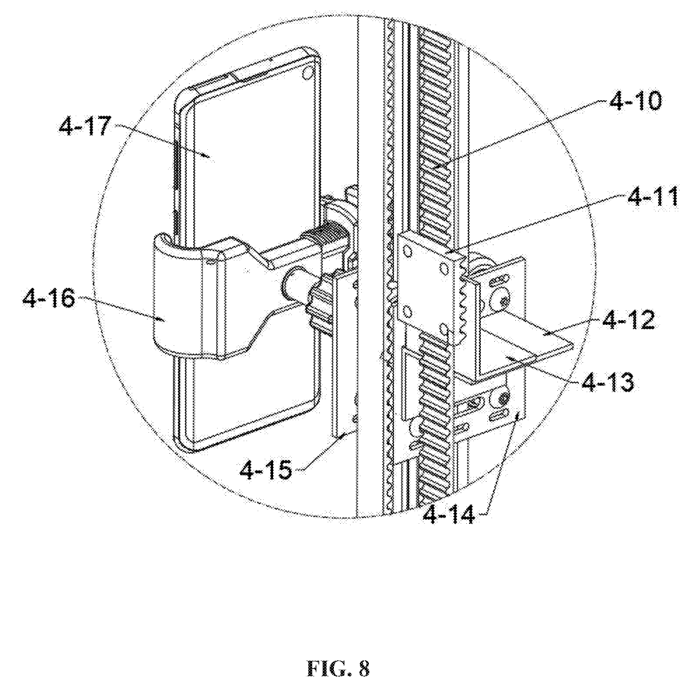

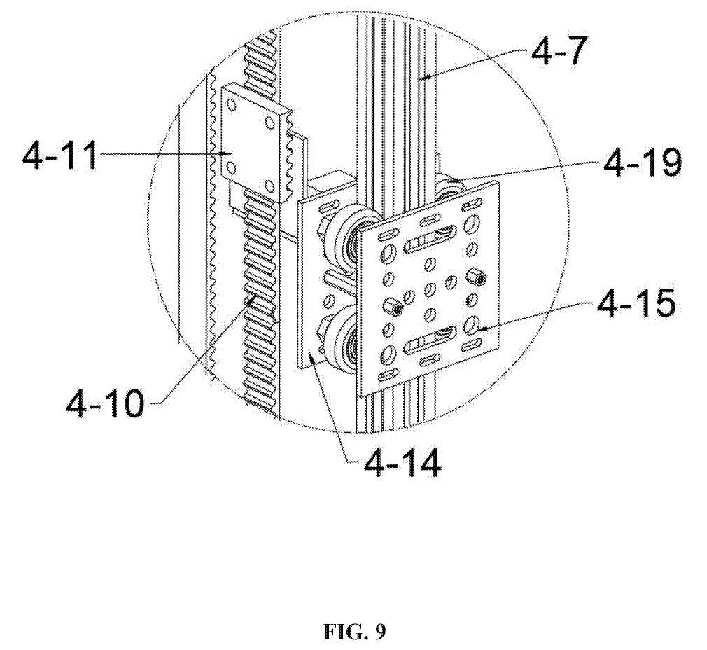

As shown in FIGS. 6-9, the multi-view imaging module 4 includes: a rotary motor 4-1, a transition plate 4-2, a rotating platform 4-4, a stepper motor mounting plate 4-5, a reverse U-shaped rotary arm, a stepper motor 4-6, a stepper motor support 4-8, a synchronous pulley 4-9, a synchronous belt 4-10, a clamping board 4-11, a first connecting plate 4-12, a second connecting plate 4-13, a small cart, an installation bracket 4-16, a visible light camera 4-17 (using an RGB-D camera), a pulley slot 4-18, and an idler 4-20.

The rotating platform 4-4, the reverse U-shaped rotary arm, the small cart, the installation bracket 4-16, and the visible light camera 4-17 are the core modules for multi-view image acquisition of plants. The reverse U-shaped rotary arm is located inside the frame support module 5 and is constructed using aluminum alloy, containing a horizontal rod 4-3 and two downward-extending arms 4-7. The horizontal rod 4-3 and the downward-extending arms 4-7 are fixedly connected using an L-shaped corner piece. The rotating platform 4-4 includes a fixed part and a rotating part. The bottom of the rotating part is connected to the transition plate 4-2, and the other side of the transition plate 4-2 and the horizontal rod 4-3 are fixedly connected with screws and nuts. The outer shell of the rotary motor 4-1 is fixed on the fixed part, and the fixed part is fixed to the center of the frame support module 5. The output of the rotary motor 4-1 is connected to the rotating part, enabling the rotating part, the reverse U-shaped rotary arm, the small cart, the installation bracket 4-16, and the visible light camera 4-17 to perform 360° rotation relative to the fixed part and the frame support module 5.

The horizontal rod 4-3 is fixed at both ends with a stepper motor mounting plate 4-5. The stepper motor mounting plate 4-5 has a stepper motor support 4-8 installed on it, which contains a stepper motor 4-6. The output shaft of the stepper motor 4-6 and the synchronous pulley 4-9 are fixedly connected using screws. The downward-extending arm 4-7 has a pulley slot 4-18 fixed at its bottom, and an idler 4-20 is rotatably connected to the pulley slot 4-18. The idler 4-20 is connected to the synchronous pulley 4-9 via a synchronous belt 4-10. The synchronous belt 4-10 is tightened between the idler 4-20 and the synchronous pulley 4-9. One end of the synchronous belt 4-10 meshes with the circular gear of the synchronous pulley 4-9, and the other end meshes with the idler 4-20 in the same way. A small cart is mounted on the synchronous belt 4-10 between the synchronous pulley 4-9 and the idler 4-20.

The small cart includes a first load plate 4-14, a second load plate 4-15, and rollers 4-19. The first load plate 4-14 and the second load plate 4-15 are located on opposite sides of the downward-extending arm 4-7. There are two rollers 4-19 on each side of the downward-extending arm 4-7, and all four rollers 4-19 are rotatably mounted on the first load plate 4-14. The rollers 4-19 on the opposite sides of the downward-extending arm 4-7 also roll along the sides of the downward-extending arm 4-7. The first load plate 4-14 is fixedly connected to the second load plate 4-15 via fixed columns. The downward-extending arm 4-7 engages with rollers 4-19 on both sides, which can move vertically along the downward-extending arm 4-7.

A first connecting plate 4-12 is bolted to one side of the first load plate 4-14. A second connecting plate 4-13 is bolted to the first connecting plate 4-12. The second connecting plate 4-13 and the clamping plate 4-11 are connected via bolts or screws, with a synchronous belt 4-10 sandwiched between them. Tightening the bolts or screws clamps the synchronous belt 4-10, enabling the small cart and synchronous belt 4-10 to operate in unison.

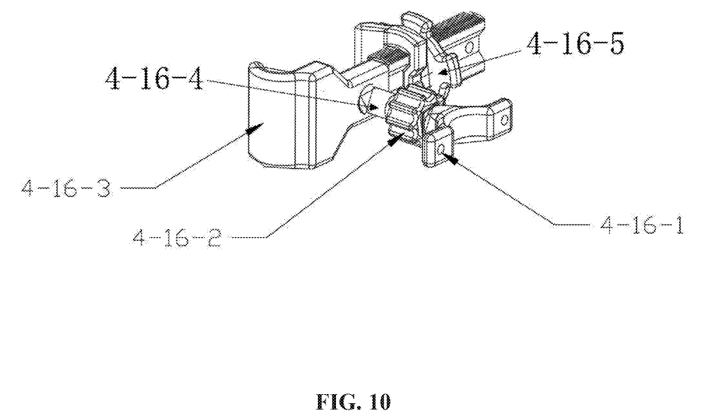

An installation bracket 4-16 is installed on the second load plate 4-15. The installation bracket 4-16 uses an existing structure to clamp a visible light camera 4-17 and adjust the angle of the visible light camera 4-17. For example, the installation bracket 4-16 includes a bracket base 4-16-1, a spherical hinge rod 4-16-4 is hinged to the bracket base 4-16-1 via an angle locking mechanism 4-16-2, and the bracket base 4-16-1 is fixedly connected to the second load plate 4-15. The front end of the spherical hinge rod 4-16-4 is fixed with a clamping device 4-16-3. The clamping ring 4-16-5 in the clamping device 4-16-3 can clamp or release the visible light camera 4-17. To flexibly adjust the camera's imaging angle, as shown in FIG. 10, loosen the angle locking mechanism 4-16-2, and the spherical hinge rod 4-16-4 and the clamping device 4-16-3 can be rotated relative to the bracket base 4-16-1. The angle locking mechanism 4-16-2 can adjust and fix the imaging angle of the visible light camera 4-17.

Depending on the usage requirements, stepper motors 4-6 can be set at both corners of the reverse U-shaped rotary arm, and small cart, installation bracket 4-16, visible light cameras 4-17, pulley slots 4-18, and idlers 4-20 can be set on both downward-extending arms 4-7. Alternatively, a stepper motor 4-6 can be set at only one corner of the reverse U-shaped rotary arm, and a small cart, installation bracket 4-16, visible light camera 4-17, pulley slot 4-18, and idler 4-20 can be set on only one downward-extending arm 4-7.

The frame support module 5 is also equipped with a controller and a power supply. The sprocket-driven motor 1-6 in the driving wheel module 1, the rotary motor 4-1 in the multi-view imaging module 4, the stepper motor 4-6, and the visible light camera 4-17 are all connected to the controller. The sprocket-driven motor 1-6, the rotary motor 4-1, the stepper motor 4-6, the visible light camera 4-17, and the controller are all connected to the power supply.

The invention also includes a remote control device. The remote control device wirelessly connects to the controller, and can control the movement of various motors through the controller.

A method for in-situ plant phenotype collection and digital twin analysis, employing the in-situ phenotype acquisition system described herein to acquire multi-view images, comprising the following steps (i.e., acquisition steps):

First, move the platform to the target area, i.e., use the sprocket-driven motor 1-6 in the driving wheel module 1 to move the platform to the phenotype acquisition area (platform steering can be achieved by adjusting the speed difference between the two driving wheel modules 1). After the plant enters the multi-view imaging module 4 inside the platform, fine-tune the platform position to place the plant in the center of the module. Then, adjust the height of the visible light camera 4-17 according to the plant height. Specifically, start the stepper motor 4-6 to drive the synchronous pulley 4-9 to rotate, and the synchronous pulley 4-9 meshes with the idler 4-20 through the synchronous belt 4-10 to transmit power; the synchronous belt 4-10 is fixed on the second connecting plate 4-13 with a clamping board 4-11, and the second connecting plate 4-13 is connected to the first load plate 4-14 through the first connecting plate 4-12, thereby converting the belt drive into vertical movement of the small cart, to achieve camera height adjustment.

For shorter plants, i.e., plants with a height below the preset height, after adjusting the visible light camera 4-17 to the appropriate height, adjust the camera shooting angle using the angle locking mechanism 4-16-2. Once the view is complete and clear, capture one image. Subsequently, start the rotary motor, i.e., rotate the motor 4-1 to drive the rotating platform 4-4 to rotate, and then through the transition plate 4-2 to synchronously rotate the horizontal rod 4-3 of the reverse U-shaped arm and the downward-extending arm 4-7, thereby synchronously rotating the visible light camera 4-17 on the small cart. After rotating by a certain angle, the rotary motor 4-1 stops, and the visible light camera 4-17 pauses, capturing the visible light image from this perspective, and repeating this process until a full week's worth of images are obtained. This invention uses intermittent shooting, i.e., rotary motor rotation-stop-capture-then rotation, to complete the entire week's image acquisition. After acquiring multi-view images, the data will be imported into the server for subsequent processing.

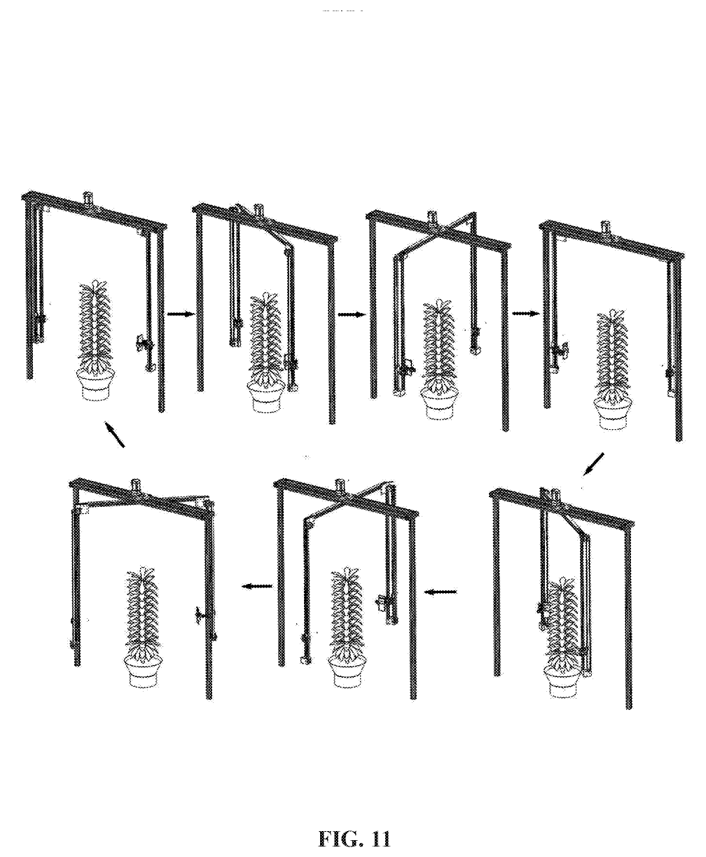

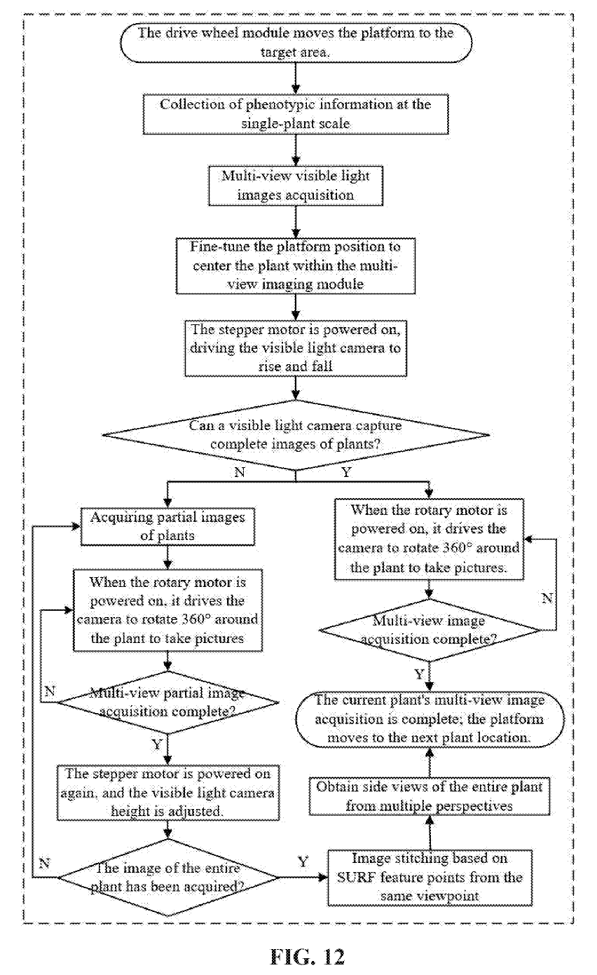

If the plant is tall, a single acquisition cannot cover the entire plant, then use a scanning method along a single view to acquire images. Specifically, start the stepper motor 4-6, move the visible light camera 4-17 to the bottom of the downward-extending arm 4-7 and stop; adjust the camera shooting angle of the visible light camera 4-17 to be parallel to the plant, that is, shoot the plant from the front, and set the visible light camera 4-17 to scanning mode. Subsequently, start the stepper motor 4-6 to drive the visible light camera 4-17 to scan the entire plant along the vertical upward direction, i.e., the individual plant 2. The built-in stitching algorithm of visible light camera 4-17 can stitch scanned images in real time, and stop scanning after a complete plant image is generated. Next, start the rotary motor 4-1, rotate the visible light camera 4-17 to a certain angle and stop, and repeat the above scanning acquisition steps. To clearly demonstrate the multi-view imaging process, FIG. 11 shows a schematic diagram of the multi-view imaging module 4 acquiring multi-view images (for simplicity, the images acquired with an interval of 30° are used as an example). The entire multi-view image acquisition flow is shown in FIG. 12.

After acquiring multi-view images, the data is imported into the server for subsequent processing (i.e., processing for digital twin analysis).The purpose of this section is to convert the multi-view image sequence acquired in the aforementioned steps into a complete, topologically correct, geometrically accurate, and parameterizable functional-structural digital twin model through a set of automated and high-precision algorithm processes. This framework overcomes the limitations of traditional three-dimensional reconstruction, which is limited to "point cloud shells" without structure, and the specific implementation process is as follows (i.e., the following steps for digital twin analysis):

(I) Multi-view 3D reconstruction and point cloud pre-processing: Input the multi-view high-resolution visible light images obtained in the above process into algorithms based on Structure-from-Motion (SFM) and Multi-View Stereo (MVS) to process. Through camera network calibration and multi-view stereo matching, generate dense three-dimensional point clouds for each plant. Subsequently, to improve the accuracy of subsequent segmentation, pre-processing operations such as manual removal of irrelevant points, statistical noise filtering, and edge artifact correction are performed on the original reconstructed point cloud to obtain clean point cloud data.

(II) Organ point cloud semantic segmentation method based on layered strategy: ① Data preparation. Based on the high-quality point cloud data obtained in step (I), construct a two-stage point cloud training dataset containing leaf and stem system (petiole and main stem), and petiole and main stem. This dataset is specifically used to train the subsequent deep learning segmentation model. ② Training and execution of layered semantic segmentation model. Using a layered segmentation strategy based on PointNet++ multi-scale grouping (MSG) architecture, perform precise point-level organ classification on the pre-processed point cloud. The technical advantage of this strategy is to decompose the complex "three-class" task into two simpler "two-class" tasks, effectively reducing the learning difficulty of the model and significantly improving the segmentation accuracy of similar organs (such as main stem and petiole). First stage (coarse segmentation): As input, the complete single plant point cloud is classified into two predefined categories, "leaf" and "stem system", through the segmentation model trained in the first stage. The "stem system" category includes a composite category of the main stem and all petioles. Second stage (fine segmentation): The "stem system" sub-cloud obtained in the first stage is separated, and it is used as the input of the second segmentation model. Further classify the points in this sub-cloud into two categories, "main stem" and "petiole". ③ Output and application. After the layered segmentation process, the final output is a completely semantic plant point cloud. Each point in the point cloud is assigned a precise semantic label of "leaf", "main stem" or "petiole", which provides key semantic prior information for subsequent topology extraction, organ-level parameter calculation, and functional-structural model construction.

(III) Semantic-aware skeleton point extraction and skeleton graph generation: A semantic-aware Laplacian contraction algorithm is used to extract the center line skeleton points of the stem system. This algorithm utilizes the "main stem" and "petiole" semantic labels assigned in the previous step (II), and applies dynamic weights during the point cloud contraction process. Specifically, a large contraction weight is applied to the points marked as "main stem" to ensure the robustness of its structure; while a smaller contraction weight is applied to the points marked as "petiole" to preserve its fine morphology. This differentiated treatment solves the problem of topological break or detail loss caused by scale differences (thick main stem and thin petiole) in traditional method. Subsequently, the extracted unordered skeleton point set is established into a skeleton topology connection using the Minimum Spanning Tree (MST) algorithm, generating a clear, non-loop skeleton graph.

(IV) Leaf mesh model construction. In the leaf mesh model construction stage, based on the leaf point cloud obtained in step (II), we propose an adaptive reconstruction method. This method can automatically adjust the key reconstruction parameters according to the unique morphological features of the leaf (such as edge serrations and surface curvature) and the unevenness of the point cloud density, thereby robustly generating a surface model that retains fine geometric details.

Specifically, the adaptive reconstruction method automatically adjusts the reconstruction parameters through analysis of the point cloud data itself, including the following steps:

1. Step 1: pre-processing of point cloud data. To address the issue of uneven point cloud distribution, this invention first detects "sparse regions" in the data. Specifically, it measures the distance between each point and its surrounding neighboring points. The larger the distance, the more isolated the point. By statistically analyzing the distribution of distances, points that deviate significantly from the average value (more than 1.5 times the standard deviation) are marked as sparse points. This is similar to identifying individuals with widely dispersed positions in a crowd.

After identifying sparse regions, this invention supplements new data points in these areas. The method of supplementing points is to use the dense points surrounding the sparse points as references and calculate new point positions using weighted calculations, effectively "interpolating" to fill in the gaps. The number of points added is automatically adjusted based on the degree of sparsity: when the proportion of sparse points exceeds 10%, the number of added points is increased; when the proportion is lower, a moderate number of points are added to avoid excessive manual intervention.

2. Step 2: automatic estimation of reconstruction parameters. Unlike traditional methods that use fixed parameters, the present invention automatically estimates initial parameters based on the actual condition of the point cloud. Specifically, this includes: counting the total number of points to determine the scale; measuring the distance between points to assess data density; calculating the point cloud bounding box to determine the physical size of the leaf. For small-scale data with fewer points (less than 300 points), a conservative reconstruction strategy is adopted to avoid introducing noise; for large-scale data with more points (over 800 points), a refined reconstruction strategy is adopted to fully utilize the data; at the same time, parameters such as the spatial search range are adjusted according to the leaf size. This approach allows the reconstruction parameters to match the data characteristics.

This invention automatically estimates initial parameters based on three key features of the point cloud, ensuring that the parameter configuration matches the data characteristics.

2.1 Point cloud feature analysis:

This invention first extracts three-dimensional features from the point cloud:

(1) Quantity analysis:

The total number of points (n_points) is used as a direct indicator of the data quantity. The point cloud is divided into three levels based on the number of points: 1) Small quantity: less than 300 points (typically leaf local or edge regions); 2) Medium quantity: between 300-800 points (main body of the leaf); 3) Large quantity: more than 800 points (complete leaf or high-density scan).

(2) Density measurement:

The K-Nearest Neighbors (KNN) method is used to measure local point density. Randomly sample 500 representative points, and search for its 6 nearest neighbors for each sampling point; calculate the average distance (avg_distance) between these neighbor points as the overall density index. The standard deviation (std_distance) of the distances is also calculated, reflecting the uniformity of the density distribution. A smaller avg_distance indicates a denser point cloud, while a larger std_distance indicates a less uniform density distribution.

(3) Leaf physical size estimation:

The axis-aligned bounding box of the point cloud is constructed. The lengths of the three sides of the bounding box are extracted, and the maximum value (max_extent) is used as the feature of the leaf. The leaf is then classified based on max_extent: 1) Small leaf: max_extent < 0.1 meter (e.g., small herbaceous plant leaves); 2) Medium leaf: 0.1 ≤ max_extent < 0.5 meter (e.g., common broadleaf tree leaves); 3) Large leaf: max_extent > 0.5 meter (e.g., large tropical plant leaves).

2.2 Initial parameter adaptive estimation:

Based on the three features above, this invention automatically estimates the following key reconstruction parameters:

(1) Number of target sampling points (target_points):

Purpose: controls the effective number of points used in subsequent reconstruction, affecting calculation efficiency and reconstruction accuracy.

Estimation strategy: small quantity point cloud: set to max (preset minimum, min (250, n_points)), to avoid oversampling and noise amplification; medium quantity point cloud: set to max (preset minimum, min (400, n_points * 0.7)), to moderately reduce sampling points and improve efficiency; large quantity point cloud: set to max (preset minimum, min (600, n_points * 0.6)), to fully utilize data while controlling the computational load.

This tiered strategy optimizes the use of computational resources while ensuring reconstruction quality.

(2) Minimum search radius for moving least squares (mls_search_radius):

Purpose: defines the local neighborhood range for smoothing the point cloud, affecting the surface smoothness.

Estimation strategy: adaptively adjusted based on the distance between points: small quantity: set to avg_distance * 3.0, to compensate for insufficient points; medium quantity: set to avg_distance * 2.5, to balance accuracy and smoothness; large quantity: set to avg_distance * 2.0, to retain more detailed features in a smaller range.

Ensures that sufficient neighborhood information is captured, regardless of the point cloud density, for smoothing.

(3) Poisson reconstruction depth:

Purpose: controls the number of subdivisions in the octree used for Poisson reconstruction, directly determining the fineness of the reconstructed mesh.

Estimation strategy: small quantity point cloud: depth = 8 (shallower tree depth, to avoid overfitting sparse data); medium quantity point cloud: depth = 10 (standard accuracy, suitable for most application scenarios); large quantity point cloud: depth = 11 (higher accuracy, to fully leverage data advantages).

A deeper octree can capture more fine surface details, but also requires more data support.

(4) Maximum number of nearest neighbors (max_nn):

Purpose: limits the maximum number of neighboring points considered for each point during calculation, affecting the stability of the calculation.

Estimation strategy: small quantity: max_nn = 20 (fewer neighbors to avoid introducing noise from distant points); medium quantity: max_nn = 30 (standard setting); large quantity: max_nn = 40 (more neighbors to improve calculation robustness).

(5) Ball radius multiplier (ball_radius_multiplier):

Purpose: defines the multiplier of the ball radius relative to the average point-to-point distance in the Ball Pivoting algorithm, affecting the continuity of surface reconstruction.

Estimation strategy: adjusted based on leaf physical size: small leaf (max_extent < 0.1 meter): multiplier = 2.0, to avoid crossing leaf edges; medium leaf (0.1 ≤ max_extent < 0.5 meter): multiplier = 2.5, standard configuration; large leaf (max_extent ≥ 0.5 meter): multiplier = 3.0, to improve large-scale continuity.

(6) Fixed initial parameters:

Smoothing iterations (smoothing_iterations): initially set to 1 for light smoothing; density threshold percentile (density_threshold_percentile): set to 10 to filter out the 10% most sparse regions; density compensation (density_compensation): enabled by default; interpolation k-neighbors (interpolation_k_neighbors): set to 8 for sparse regions.

2.3 Build a 3D mesh model based on initial parameters:

After obtaining the adaptive estimated initial parameters, this invention builds a 3D mesh model for the leaf according to the following process:

(1) Point cloud sampling:

Using the farthest point sampling algorithm, the representative points are selected from the original point cloud or the density-compensated point cloud based on target_points.

This method ensures that the sampling points are evenly distributed in space, maximizing the coverage of the leaf surface.

(2) Surface smoothing:

The sampled point cloud is applied to the Moving Least Squares (MLS) algorithm, using the estimated mls_search_radius as the search radius.

The MLS algorithm fits a smooth surface within the local neighborhood, reducing measurement noise and scan errors.

(3) Poisson surface reconstruction:

Core step: using the Poisson surface reconstruction algorithm in the Open3D library, the input parameters include: depth: octree depth, controlling the mesh accuracy; width: optional parameter, representing the target width of the finest mesh cells; scale: optional parameter, affecting the scale factor of the reconstruction; linear_fit: whether to use linear fit (usually set to false for a smoother surface).

Poisson reconstruction principle: convert the normal vector field into an implicit surface by solving the Poisson equation, and then use the Marching Cubes algorithm to extract the triangular mesh.

(4) Post-processing optimization:

Density filtering: removes vertices and triangular faces with too low density in the reconstructed mesh, which are usually noise or extrapolation areas.

Mesh cleaning: remove isolated triangular faces, repair non-manifold edges, and unify the direction of the normal vectors.

Optional Laplacian smoothing, executed based on the smoothing_iterations parameter.

Through this adaptive parameter estimation and reconstruction process, this invention achieves "one-stop" processing: automatically generates high-quality 3D mesh models from any quantity and density leaf point clouds, without manual parameter tuning.

3. Step 3: reconstruction quality assessment. This invention establishes a multi-dimensional quality detection system, evaluating the reconstruction results from four aspects: (1) mesh integrity: checks whether the reconstructed 3D mesh has any holes or damage; (2) geometric accuracy: measures the distance between the original data points and the reconstructed mesh surface, and also measures the distance from the reconstructed surface to the original points in the reverse direction, which can detect extra protrusions or missing concave areas in the reconstruction; (3) coverage completeness: statistics how many original data points can be found in the reconstructed result, reflecting the completeness of the reconstruction; (4) comprehensive score: calculates the total score by weighting the above indicators, used for comparing the effects of different parameter configurations.

4. Step 4: parameter Iterative Optimization. Based on the quality assessment results, this invention adopts a phased strategy to adjust the parameters. In the first phase, it optimizes the sampling point number to address the hole problem: starting from a smaller number of points, gradually increase to find the minimum number of points that can eliminate holes, avoiding excessive sampling and wasting computational resources. In the second phase, it adjusts other parameters based on specific quality defects: if holes still exist, increase the sampling density and reconstruction depth, and strengthen the point supplementation in sparse regions; if the distance deviation is too large, reduce the smoothing range to retain more details; if the deviation fluctuates too much, enhance the smoothing to improve consistency; if the coverage is incomplete, increase the overall sampling density. Each adjustment is based on specific quality problems, not blind attempts. When continuous adjustments do not improve or reach the quality requirements, stop optimization and output the results.

(V) Construction of a high-fidelity digital twin model.

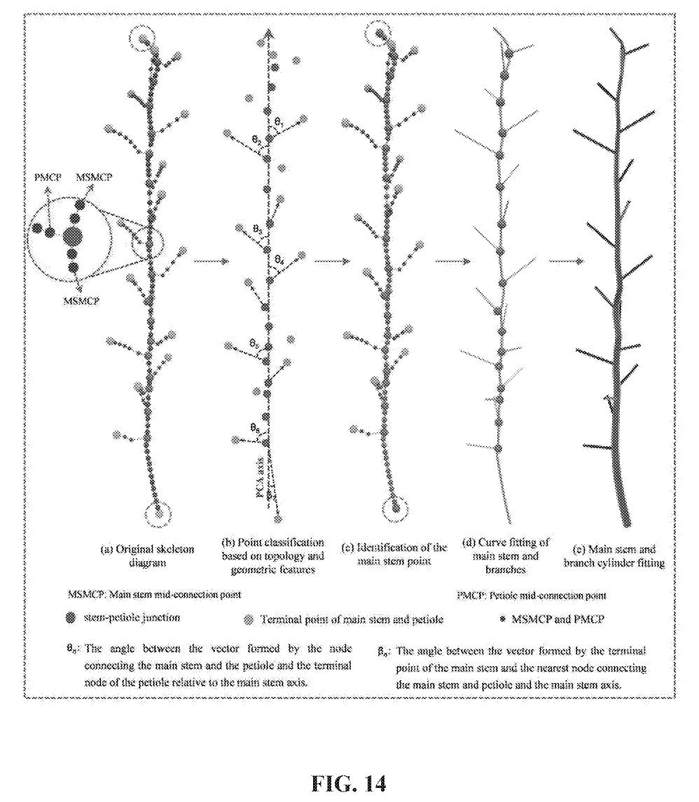

Based on the Python API for Blender, this research developed a software package for automated digital modeling, comprising a data input layer, a parsing modeling layer, and a visualization-human interaction layer. The input layer supports automatic import of skeletal diagrams and leaf mesh models generated by steps (III) and (IV) via file paths. Subsequently, for the skeletal diagram file, the developed parsing algorithm uses topological feature analysis and geometric constraint optimization to accurately identify the main stem point and petiole point of the stem system (the algorithm's principle is shown in FIG. 14). This parsing algorithm employs a two-stage topological-geometric strategy. First, by statistically analyzing the number of connections between skeletal nodes, key connection points are identified: nodes with three edges represent stem-petiole junction, connecting the upper and lower main stems and branching towards the petiole. Using these connection points as a basis, PCA (principal component analysis) is applied to the main stem and petiole connection points to extract the main stem's main axis direction, establishing a global spatial reference system. In the second stage, the issue of distinguishing the terminal point (which may be the petiole terminal point or the main stem terminal point) is addressed: the angle between the main stem axis and the vector formed by the stem-petiole junction to the terminal point, denoted as θₙ, is recorded. This stem-petiole junction satisfies the condition that it is the closest to the terminal point and has an intermediate connection point (such as the main stem intermediate connection point (MSMCP) or the petiole intermediate connection point (PMCP)) between it and the terminal point. Based on the statistical characteristics of the normal distribution of poplar seedling petiole branch angles with a mean value of 50° and extremely low probability in the range of 0-20°, a threshold of 20° is set for discrimination. If θₙ > 20°, the terminal point is identified as the petiole terminal point; otherwise, it is identified as the main stem terminal point. The same angle constraint is also applied to the detection of intermediate connection points. The innovation of this method lies in combining topological features (edge count statistics) and geometric constraints (angle thresholds) to first use edge count to quickly locate structural key points and determine the main axis, and then use angle constraints to eliminate ambiguity in the terminal point , thereby preventing the misidentification of the main stem terminal point as the petiole terminal point, and achieving accurate separation of the main stem end point and the petiole end point .

Distinguish by number of edges, the points with three edges are the stem-petiole connection point (the big red point in (a) of FIG. 14); the points with two edges: all blue points, part of which is on the main stem (the middle connection point of the main stem ), and part of which is on the petiole (the middle connection point of the petiole ); the points with one edge: the end point of the petiole and the two end points of the main stem (bottom and top) .

Terminal point: only connected to one point, i.e., all terminal points in the figure, including the top and bottom terminal points of the main stem, and the petiole terminal point.

The main stem point has three categories: the stem-petiole junction with three edges (large red point in FIG. 14 (a)), the main stem intermediate connection point with two edges (blue medium-sized point in FIG. 14 (a)), and the terminal point with one edge (large green point in FIG. 14 (a), top and bottom ends).

Petiole point: points on the petiole, not on the main stem. This includes the petiole intermediate connection point and the petiole terminal point.

Intermediate connection points: all points with two edges, i.e., all blue points. If on the main stem, it is called the main stem intermediate connection point; if on the petiole, it is called the petiole intermediate connection point.

When all main stem points are identified, all main stem points are represented by red points in FIG. 14(c), which means that all main stem points have been identified, including: main stem intermediate connection point (the large blue points in FIG. 14(a), the small red points in FIG. 14(c), with two edges), the stem-petiole junction (the large red point in the figure, with three edges) and the terminal points (the two large green points above and below in FIG. 14(a), the two large red points above and below in FIG. 14(c)).

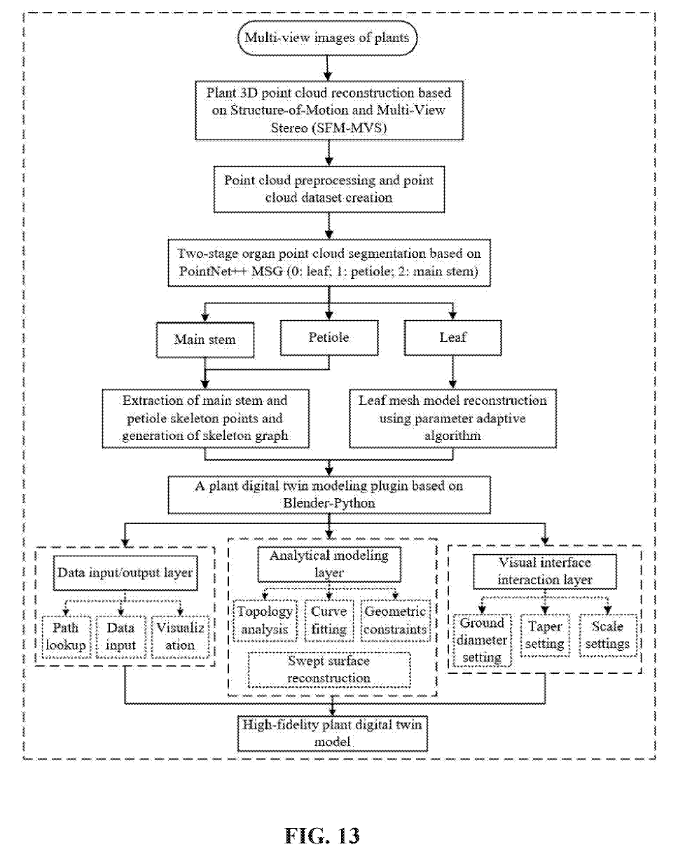

Based on this, B-spline curve fitting is applied to the main stem node sequence to generate a smooth and continuous center path; the petiole point is fitted with a straight line to generate a corresponding path. Finally, along the fitted main stem path and petiole path, a surface reconstruction method is used to generate a solid model. This method can simulate the natural shape of the plant stem and petiole gradually thinning from the base to the top, thereby constructing a three-dimensional stem system structure with high realism and parametric features. Finally, the constructed stem system structure and the imported leaf mesh model are connected and integrated in space to form a complete high-fidelity digital twin of the plant. To accurately simulate the scale and shape of the plant in the real world, the visualization-human interaction layer supports manual setting of ground diameter, cone angle, etc., to achieve precise control of the plant's structural shape. The entire modeling process framework of this invention is shown in FIG. 13.

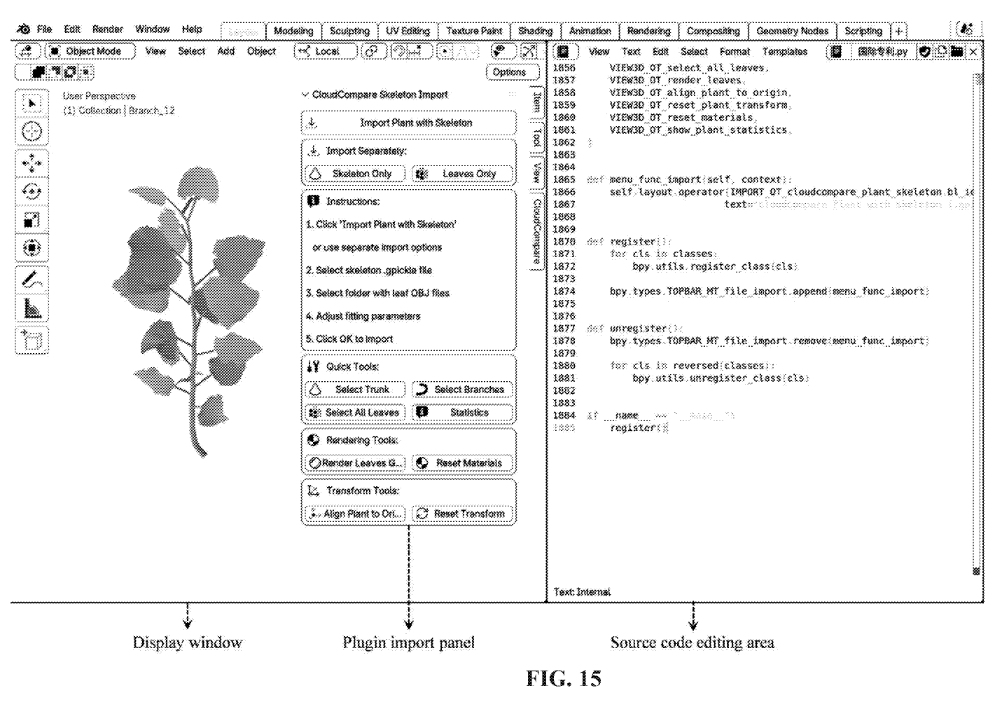

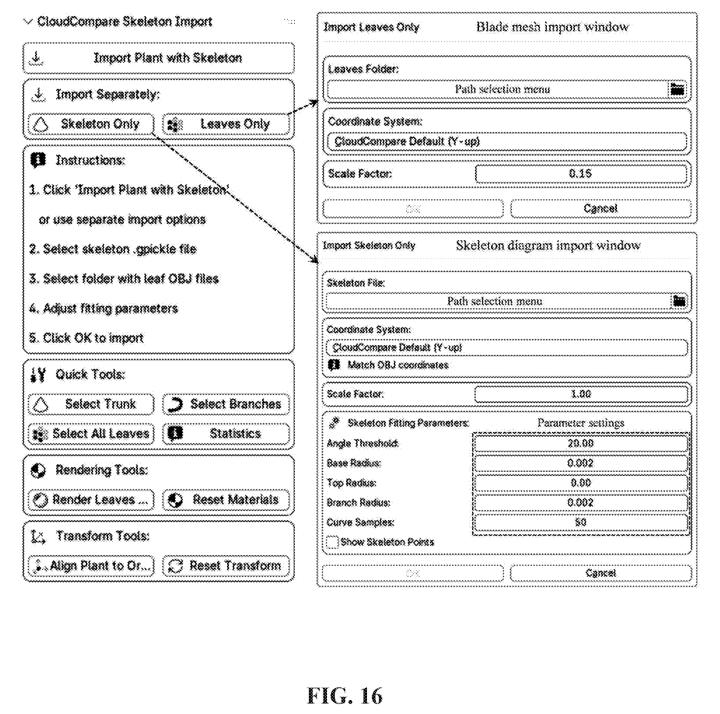

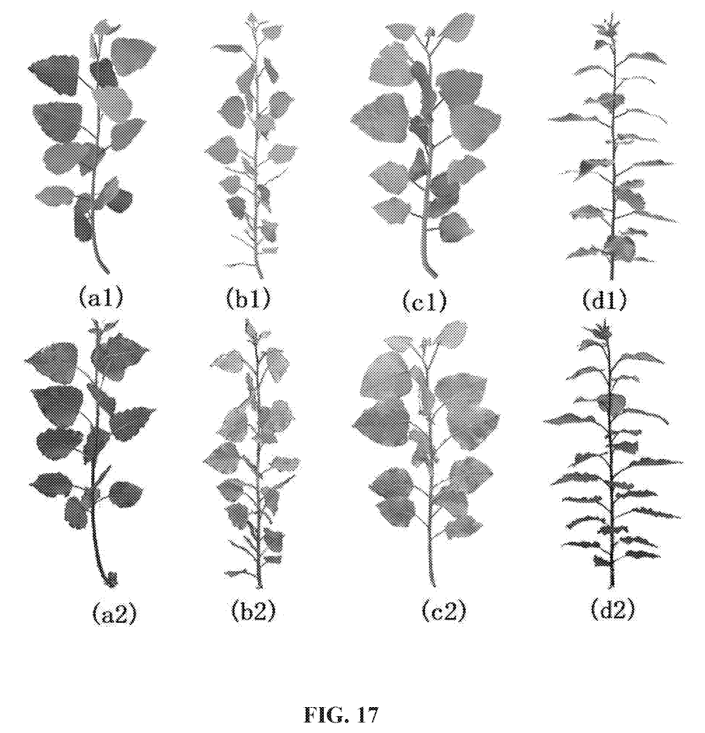

Based on the above (IV) algorithm and principle, this research utilizes the Blender-Python API to develop a highly customized integrated tool panel. This panel integrates Blender's built-in display window, the source code editing area of the panel, and the independently developed skeletal and leaf import interface (as shown in FIG. 15). The skeletal and leaf import panel contains multiple modules, such as: data import module, user guide module, quick selection tool module, rendering tool module, and coordinate conversion tool module (as shown in FIG. 16). The data import module contains skeletal import and leaf import panels; the leaf import panel can select import paths and set scaling coefficients (scale parameters); the skeletal import panel, in addition to being able to select paths, also includes various parameter settings, such as: angle threshold, base radius, top radius, branch radius, curve sampling point setting, etc. (i.e., parametric modeling, parametric digital twin model). By using the customized integrated tool panel developed by this invention, a final high-fidelity digital twin model of the plant is constructed, as shown in FIG. 17 (a1), (b1), (c1), and (d1) are the digital twin models constructed by this invention, and (a2), (b2), (c2), and (d2) are the original plant point cloud.

### Specifically:

Scaling coefficient: the scaling coefficient of the point cloud model compared to the Blender entity model.

Angle threshold: the angle θₙ mentioned above.

Base radius: the radius of the main stem (fitted cylinder) near the ground (commonly known as the ground diameter).

Top radius: the radius of the main stem (fitted cylinder) away from the ground.

Branch radius: the radius of the petiole (fitted cylinder).

Curve sampling points: the number of curve sampling points used in the B-spline curve fitting.

Example 1: quantitative verification of core algorithm components

(1) Experiment objective:

To quantitatively evaluate the accuracy of the digital twin analysis method proposed in this invention (see the "Invention Content" section) in terms of morphology, this example design a precision validation experiment. The core objective of this experiment is to systematically validate the accuracy and reliability of the digital twin model generated by this invention in extracting key plant phenotypic parameters by comparing the correlation between manually measured values and model-estimated values.
(1) Experiment design and steps:
(2) Experimental materials and sample selection:

The experimental subjects selected 4 poplar seedling varieties with good growth status and representative plant types, 10 plants of each variety, totaling 40 plants (N=40), with a growth cycle of 60 to 120 days. Before starting the experiment, each seedling was numbered.

(2) Manual measurement (gold standard):

Two experiment personnel independently measured six key phenotypic parameters for each sample using professional measurement tools before scanning. The average value was used as the "manual measurement value" for that parameter. The measurement methods and definitions are as follows:

Plant height: measured the vertical distance from the base of the stem (at the soil surface) to the top of the plant using a steel ruler with millimeter accuracy.

Crown diameter: measured the maximum width of the leaf outline in two perpendicular directions from above the plant using a steel ruler. The average value was used as the crown diameter.

Leaf length: measured the maximum straight-line distance from the tip of the leaf to the leaf-petiole connection point using a 0.02mm precision electronic caliper.

Leaf width: measured the maximum width of the leaf in a direction perpendicular to the main leaf vein using an electronic caliper.

Petiole base angle: defined as the angle between the tangent of the petiole curve at the attachment point of the main stem and the main stem axis. This angle was measured using a digital protractor.

Petiole inclination angle: defined as the angle formed by the line from the attachment point of the petiole curve on the main stem to the leaf-petiole connection point and the main stem axis. This angle was measured using a digital protractor.

When measuring leaf-related parameters, a stratified random sampling method was used. Two leaves were selected from the upper, middle, and lower three layers of each plant, and their leaf length and leaf width were measured. A total of 6 leaves were collected per plant, resulting in 240 samples for leaf length and 240 samples for leaf width. The parameters of the corresponding leaves, including petiole base angle and petiole inclination angle, were also measured in the same sample quantity.

(3) Automatic model extraction:

After manual measurement, the "multi-view collaborative plant in-situ phenotype system" (as shown in FIG. 1-10) was used to acquire multi-view images for all 40 samples (the acquisition process is shown in FIG. 12). The acquired image sequence was input into the digital twin analysis method of this invention (the process is shown in FIG. 13) to automatically generate a high-fidelity, parameterized digital twin model for each sample.

Based on the generated digital twin model, its built-in topological skeleton information (as shown in FIG. 14) and parameterized geometric entities can be automatically calculated using algorithms to correspond to the 6 phenotypic parameters measured manually. The calculation method for phenotypic parameters can be: the actual plant to point cloud model, with a proportion factor u1; the point cloud model to the digital twin model, also has a proportion factor u2, the phenotypic parameters measured in the software of the digital twin model, multiplied by u1 and u2, to obtain the final real-world value, which is automatically calculated by the algorithm.

(1) Results analysis and conclusion:

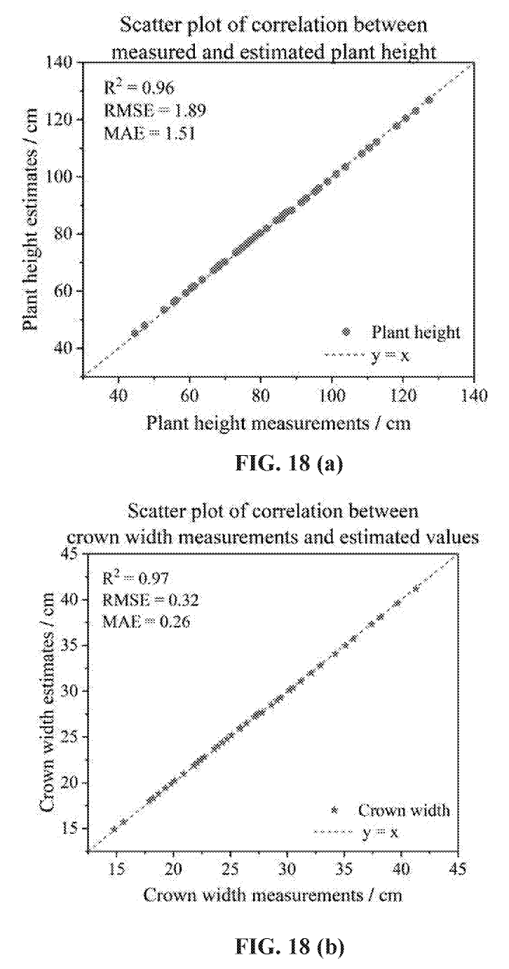

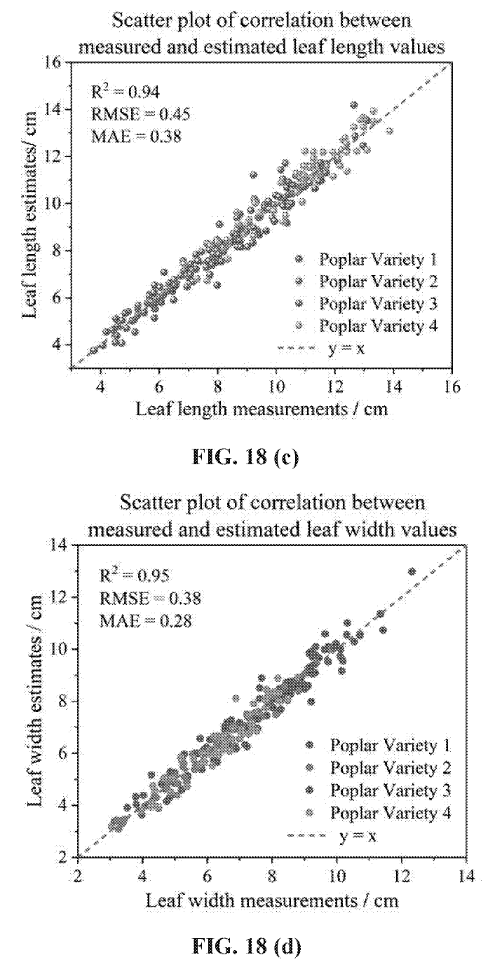

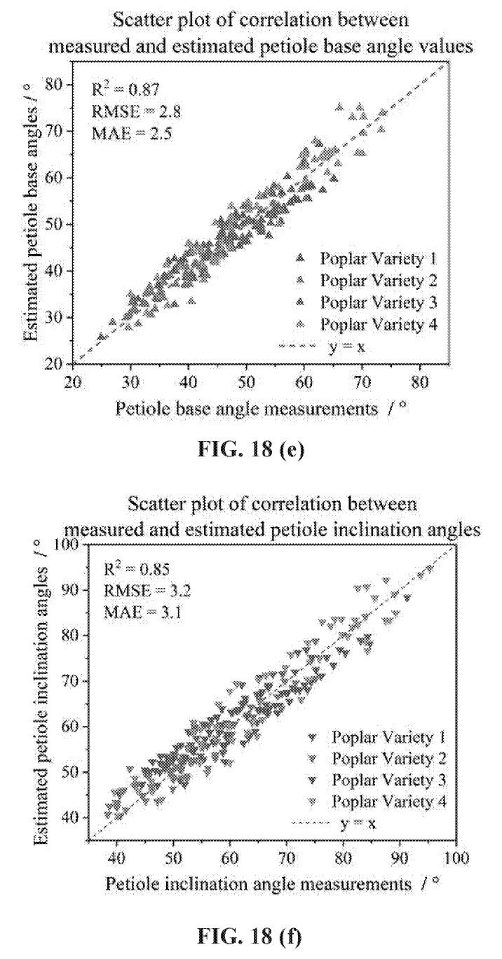

To evaluate the consistency between model-estimated values and manual measurements, we plotted a scatter plot of the actual measurements versus the model-estimated values (as shown in FIG. 18) and visualized the data. The experimental results are shown in FIG. 18. From the figure, it can be seen that all 6 phenotypic parameters show a strong linear correlation between the model-estimated values and the manual measurements. The data points are closely distributed on both sides of the 1:1 reference line.

FIGS. 18(a) to 18(f) show the scatter plot of the model-estimated values (Y-axis) and the manual measurements (X-axis) for the 6 parameters of plant height, crown diameter, leaf length, leaf width, petiole base angle, and petiole inclination angle, respectively. The dashed line is the 1:1 reference line. The specific quantitative analysis results are as follows: The coefficient of determination for plant height (FIG. 18(a)) R² =0.96, indicating that the model-estimated height is almost completely consistent with the actual height. The coefficients of determination for crown diameter (FIG. 18(b)) R² =0.97, which proves that the model can accurately reflect the overall expansion of the plant's crown. The coefficients of determination for leaf length (FIG. 18(c)) R²=0.94, and the coefficients of determination for leaf width (FIG. 18(d)) R²=0.95, respectively, showing the high precision of this invention in measuring fine-scale organ-level dimensions. The coefficients of determination of the two key spatial attitude parameters, petiole base angle (FIG. 18(e)) and petiole inclination angle (FIG. 18(f)), also reached R²=0.87 and R²=0.85 respectively, which strongly proves the accuracy of the topological structure and spatial direction of the model constructed by the present invention.

### Conclusion:

The above series of verification results with high coefficients of determination (R² are all greater than 0.85) strongly prove that the model constructed by the digital twin analysis method proposed in this invention is not only visually realistic, but also reaches a level that is highly consistent with the "gold standard" manual measurement in terms of quantitative accuracy of key phenotypic parameters. This invention has successfully achieved the non-destructive, automated, and high-precision measurement of plant phenotypes. The results are highly accurate and reliable, providing a solid technical foundation for subsequent precision agriculture research and applications.

This invention's hardware acquisition platform can perform in-situ, non-destructive multi-view image acquisition for a single plant in controlled and natural environments. By coordinating the control of vertical and horizontal adjustment mechanisms, it can achieve adaptive image acquisition under different height and angle conditions. The accompanying analysis method proposes an end-to-end automated processing process, which reconstructs the multi-view image sequence into a high-fidelity digital twin model with topological reasonableness, structural integrity, and parameterized features. The core innovation of this method is to integrate multiple technology modules, including semantic segmentation, skeleton extraction, and parameterization modeling. A specially developed parameterization modeling component can automatically parse the plant stem information extracted from the point cloud, relying on built-in topological recognition and geometric generation algorithms to construct accurate topological plant stem systems. Further, the stem structure is further spatially aligned and automatically assembled with the pre-built leaf mesh model library to finally generate a high-fidelity plant digital twin model. This invention has automated the entire process from in-situ acquisition to a digital twin model that can be directly used for simulation analysis, providing key technical support for precision plant phenotype analysis, virtual growth simulation, and environmental adaptability research.

The protection scope of this invention includes, but not limited to, the above embodiments. The protection scope of this invention is determined by the patent claims. Any replacement, modification, or improvement of this technology that can be easily thought of by technical personnel in the field falls within the protection scope of this invention.

What is claimed is:

1. A multi-view collaborative plant in-situ phenotype acquisition system, includes a hardware acquisition platform; the hardware acquisition platform includes a driving wheel module (1), omni-directional wheels (3), a multi-view imaging module (4), and a frame support module (5); the front sides of the frame support module (5) are equipped with omni-directional wheels (3) at their bottom, and the rear sides are equipped with a driving wheel module (1) at their bottom;
the multi-view imaging module (4) includes a rotary motor (4-1), a rotating platform (4-4), a reverse U-shaped rotary arm, a stepper motor (4-6), a small cart, an installation bracket (4-16), and a visible light camera (4-17); the reverse U-shaped rotary arm is located inside the frame support module (5), including a horizontal rod (4-3) and two downward-extending arms (4-7) fixed at the ends of the horizontal rod (4-3); the rotating platform (4-4) includes a fixed component and a rotary component; the fixed component is connected to the frame support module (5), and the rotary motor (4-1) is mounted on the fixed component; the output of the rotary motor (4-1) is connected to the rotary component, and the rotary component is connected to the center of the horizontal rod (4-3) in the reverse U-shaped rotary arm; the rotating component is connected to the central part of the horizontal rod (4-3) within the reverse U-shaped rotary arm; the rotary motor (4-1) drives the rotating component and reverse U-shaped rotary arm to rotate relative to the fixed component; the small cart is slidingly or rollably connected to the downward-extending arm (4-7); the installation bracket (4-16) is connected to the small cart, and the installation bracket (4-16) is used to clamp the visible light camera (4-17) and adjust the angle of the visible light camera (4-17); the reverse U-shaped rotary arm is equipped with a stepper motor (4-6), the stepper motors (4-6) are connected to the small cart via a belt drive mechanism, the stepper motors (4-6) drive the small cart, the installation bracket (4-16), and visible light camera (4-17) to move vertically along the downward-extending arm (4-7).

2. The multi-view collaborative plant in-situ phenotype acquisition system, as recited in claim 1, wherein: the transmission mechanism includes a synchronous pulley (4-9), a synchronous belt (4-10), a pulley slot (4-18), and an idler (4-20); the output of the stepper motor (4-6) is connected to the synchronous pulley (4-9); a pulley slot (4-18) is set on the bottom side of the downward-extending arm (4-7); The idler (4-20) rotates within the pulley slot (4-18); the idler (4-20) is connected to the synchronous pulley (4-9) through the synchronous belt (4-10); and the small cart is connected to the synchronous belt (4-10).

3. The multi-view collaborative plant in-situ phenotype acquisition system, as recited in claim 2, wherein: the multi-view imaging module (4) further includes a clamping board (4-11) and a second connecting plate (4-13); the small cart includes a first load plate (4-14), a second load plate (4-15), and rollers (4-19); the first load plate (4-14) and the second load plate (4-15) are located on the sides of the downward-extending arm (4-7); the downward-extending arm (4-7) has rollers (4-19) on the other sides; the rollers (4-19) are rotatably mounted on the first load plate (4-14) or the second load plate (4-15); the rollers (4-19) are in rolling contact with the sides of the downward-extending arm (4-7); the first load plate (4-14) is connected to the second load plate (4-15) through a fixed column;
the clamping board (4-11) and the second connecting plate (4-13) are connected by bolts, and the synchronous belt (4-10) is clamped between the clamping board (4-11) and the second connecting plate (4-13); and the first load plate (4-14) or the second load plate (4-15) is directly or indirectly fixed to the second connecting plate (4-13).

4. The multi-view collaborative plant in-situ phenotype acquisition system, as recited in claim 1, wherein: the driving wheel module (1) includes a wheel (1-2), a chain (1-3), a driven sprocket (1-4), a driving sprocket (1-5), and a sprocket-driven motor (1-6); the sprocket-driven motor (1-6) is set on the frame support module (5); the wheel (1-2) is rotatably connected to the frame support module (5); the flange fixed on the wheel (1-2) is fixed with the driven sprocket (1-4); the driven sprocket (1-4) is connected to the driving sprocket (1-5) through the chain (1-3); and the driving sprocket (1-5) is connected to the output shaft of the sprocket-driven motor (1-6).

5. The multi-view collaborative plant in-situ phenotype acquisition system, as recited in claim 1, wherein: the frame support module (5) further includes a controller and a power supply; the sprocket-driven motor (1-6) in the drive wheel module (1), the rotary motor (4-1), stepper motor (4-6), and visible light camera (4-17) in the multi-view imaging module (4) are all connected to the controller; the sprocket-driven motor (1-6), rotary motor (4-1), stepper motors (4-6), visible light camera (4-17), and controller are all connected to the power supply.

6. A method for acquiring multi-view visible light images of plants, using the multi-view collaborative plant in-situ phenotype acquisition system described in claim 1, wherein the acquisition steps include:
(A1) moving the hardware acquisition platform to the target area, that is, by controlling the drive wheel module (1) to maneuver the hardware acquisition platform into the phenotype acquisition zone, ultimately placing the plant in the central position of the multi-view imaging module (4) within the hardware acquisition platform;
(A2) adjusting the height of the visible light camera (4-17) according to the plant height using stepper motors (4-6);
(A3) adjusting the shooting angle of the visible light camera (4-17) by the installation bracket (4-16); after that, the visible light camera (4-17) takes a view, and after taking the view, collects an image;
(A4) starting the rotary motor (4-1), rotating the rotating component within the rotating platform (4-4), thereby synchronously rotating the reverse U-shaped rotary arm, which in turn rotates the visible light camera (4-17) on the cart, after rotating to a certain angle, the rotary motor (4-1) stops rotating;
(A5) repeating steps (A3) and (A4) until the entire circumference of the image is acquired.

7. The method for acquiring multi-view visible light images of plants, as recited in claim 6, wherein: the acquisition steps specifically include:
(A1) moving the hardware acquisition platform to the target area, i.e., controlling the sprocket-driven motor (1-6) in driving wheel module (1) to move the hardware acquisition platform to the phenotype acquisition area, ultimately placing the plant in the central position of the multi-view imaging module (4) within the hardware acquisition platform;
if the plant height is below the preset height, steps (A2) to (A5) are executed; if the plant height is above the preset height, steps (A6) to (A9) are executed;
(A2) adjusting the height of the visible light camera (4-17) using the stepper motors (4-6) according to the plant height; specifically, the stepper motor (4-6) moves the synchronous pulley (4-9) through the synchronous belt (4-10), the synchronous belt (4-10) drives the cart and the visible light camera (4-17) to move up and down until they are adjusted to the appropriate height;
(A3) adjusting the shooting angle of the visible light camera (4-17) by installation bracket (4-16) so that the shooting angle is parallel to the plant; after that, the visible light camera (4-17) takes a view, and after taking the view, collects an image;
(A4) starting the rotary motor (4-1), rotating the rotating component within the rotating platform (4-4), thereby synchronously rotating the reverse U-shaped rotary arm, which in turn rotates the visible light camera (4-17) on the cart, after rotating to a certain angle, the rotary motor (4-1) stops rotating;
(A5) repeating steps (A3) and (A4) until the entire circumference of the image is acquired;
(A6) starting the stepper motor (4-6), the stepper motor (4-6) moves the synchronous belt (4-10) through the synchronous pulley (4-9), the synchronous belt (4-10) moves the cart and the visible light camera (4-17) downwards, and moves the visible light camera (4-17) to the bottom of the downward-extending arm (4-7);
(A7) adjusting the shooting angle of the visible light camera (4-17) by installation bracket (4-16) so that the shooting angle is parallel to the plant; set the visible light camera (4-17) to scanning mode, then start the stepper motor (4-6), drives the visible light camera (4-17) to move vertically upward and scan the entire plant, the visible light camera (4-17) has an integrated splicing algorithm to real-time splice the scanning image, after generating the entire plant image, stop scanning;
(A8) starting the rotary motor (4-1), rotating the rotating component within the rotating platform (4-4), thereby synchronously rotating the reverse U-shaped rotary arm, which in turn rotates the visible light camera (4-17) on the cart, after rotating to a certain angle, the rotary motor (4-1) stops rotating;
(A9) repeat steps (A6)-(A8) until the entire week of image acquisition of the plant is completed.

8. A method for in-situ plant phenotype acquisition and digital twin analysis, characterized by: using the multi-view visible light image acquisition method described in claim 6 to acquire multiple plants' multi-view visible light images, then performing the digital twin analysis steps;
the digital twin analysis steps include:
(B1) inputting each plant's multi-view visible light image into the algorithm based on motion recovery structure and multi-view 3D for processing, generating a dense 3D point cloud for each plant, and performing pre-processing operations on the dense 3D point cloud of each plant to obtain the pre-processed point cloud data for each plant;
(B2) point cloud segmentation:
(B21) constructing a point cloud training dataset for leaf and stem systems based on pre-processed point cloud data for each plant, as well as a point cloud training dataset for petioles and main stems; the point cloud training dataset for leaf and stem systems includes complete point clouds of individual plants and the results of partitioning the point cloud of an individual plant; the results of partitioning the point cloud of an individual plant include a leaf point cloud and a stem system point cloud; the point cloud training dataset for petioles and main stems includes point clouds belonging to the stem system and the results of partitioning the point clouds belonging to the stem system ; the results of partitioning the point clouds belonging to the stem system include a main stem point cloud and a petiole point cloud ;
(B22) training the first segmentation model using the point cloud training dataset for leaf and stem systems, resulting in the first-stage segmentation model after training; training the second-stage segmentation model using the point cloud training dataset for petioles and main stems, resulting in the second-stage segmentation model after training; both the first-stage segmentation model and the second-stage segmentation model utilize a PointNet++ multi-scale grouping MSG architecture;
(B23) the plant point cloud data obtained through step (B1) is input into the trained first-stage segmentation model, dividing it into leaf point cloud and stem system point cloud, the stem system point cloud is then input into the trained second-stage segmentation model, dividing it into main stem point cloud and petiole point cloud , the results from the first-stage segmentation model and the second-stage segmentation model are fused to obtain a semantically annotated point cloud where each point is labeled as belonging to a leaf, main stem, or petiole;
(B3) based on the main stem point cloud and petiole point cloud extracted in step (B23), the Laplace contraction algorithm is used to extract the skeleton point set of the stem system; using the segmented main stem point cloud and petiole point cloud, dynamic weights are applied during the point cloud contraction process to extract an unordered skeleton point set; the unordered skeleton point set is then established into a skeleton topology connection using the Minimum Spanning Tree algorithm, generating a skeleton graph;
(B4) based on the leaf point cloud extracted in step (B23), a leaf mesh model is constructed;
(B5) constructing a digital twin model:
based on the skeleton graph generated in step (B3), the main stem point cloud and petiole point cloud in the stem system are identified, the main stem point cloud is fitted to generate a smooth and continuous main stem path; the petiole point cloud is fitted to generate a petiole path; along the fitted main stem path and petiole path, a sweeping surface reconstruction method is used to generate a physical model of the stem system;
the leaf mesh model and the stem system physical model are connected and integrated to form a complete digital twin model of the plant; the plant's phenotypic parameters are obtained through the digital twin model and a scaling factor.

9. The method for in-situ plant phenotype acquisition and digital twin analysis, as recited in claim 8, wherein: that step (B4) specifically comprises:
based on the leaf point cloud obtained in step (B23), constructing a leaf mesh model using an adaptive reconstruction method;
specifically, the adaptive reconstruction method comprises the following steps:
step (B41), identifying and enhancing sparse regions in the leaf point cloud data;
step (B42), automatically estimating initial reconstruction parameters based on three key features of the leaf point cloud data, where the key features of the point cloud data specifically include: point cloud size, point cloud data density, and leaf physical dimensions, based on these three key features, initial reconstruction parameters are automatically estimated, including the number of target sampling point, MLS search radius, Poisson reconstruction depth, ball radius multiplier, and maximum number of nearest neighbor; establish a three-dimensional mesh model of the leaf based on initial reconstruction parameters;
step (B43), evaluating the quality of the three-dimensional mesh model using metrics, including: mesh integrity, geometric accuracy, and coverage completeness, the total score is calculated by weighting all metrics to obtain the quality evaluation result;
step (B44), adjusting the reconstruction parameters based on the quality evaluation result, when continuous adjustments do not improve the results or reach the quality requirements, optimization is stopped and the results are output.

10. The method for in-situ plant phenotype acquisition and digital twin analysis, as recited in claim 8, wherein: that step (B5) specifically comprises:
step (B51), identifying key connection points by counting the number of connections between skeletal nodes: nodes with three edges are stem-petiole junctions, using stem-petiole junctions as a basis, PCA is applied to extract the main stem main axis direction, establishing a global spatial reference system;
step (B52), the angle formed by the vector from the stem-petiole junction to the terminal point relative to the main stem axis is denoted as θₙ, the stem-petiole junction node satisfies the following condition: the distance from the stem-petiole junction to the terminal point is minimized, and an intermediate connection point exists between the stem-petiole junction and the terminal point , when θₙ > 20°, the terminal point is classified as the petiole terminal point ; otherwise, it is classified as the main stem terminal point ,
step (B53), applying B-spline curve fitting to the sequence of main stem nodes to generate a smooth and continuous center path, use the straight line fitting method for the petiole nodes to generate the corresponding petiole path; along the fitted main stem path and petiole path, a stem system entity model is generated using a sweeping surface reconstruction method;
step (B54), connecting and integrating the leaf mesh model and the stem system entity model in space to form a complete plant digital twin model, the phenotypic parameters of the plant are obtained through the plant digital twin model and a scaling factor, where the scaling factor includes the ratio between the actual plant and the plant point cloud, and the ratio between the plant point cloud and the plant digital twin model.
